(19) United States
(12) Patent Application Publication
(10) Pub. No.: US 2018/0121215 A1
(43) Pub. Date: May 3, 2018

(54) DYNAMIC AND CUSTOMIZABLE USER INTERFACE PLATFORM

(71) Applicant: FLUENT SYSTEMS, INC., Stevensville, MT (US)

(72) Inventors: Gabriel D. Charbonneau, Stevensville, MT (US); Kirk L. Crews, Stevensville, MT (US)

(21) Appl. No.: 15/568,190

(22) PCT Filed: Apr. 22, 2016
(86) PCT No.: PCT/US16/28954

§ 371 Date: Oct. 20, 2017

Related U.S. Application Data
(60) Provisional application No. 62/151,929, filed on Apr. 23, 2015.

(51) Int. Cl. G06F 9/44; G06F 3/0482

(52) U.S. Cl. CPC G06F 9/4443; H04L 67/10; G06F 3/0482

(57) ABSTRACT

Systems and methods for providing dynamic graphical user interface (GUI) platforms which facilitate time-saving and operation-streamlining functionality for existing target applications. A GUI platform may include a GUI which executes command scripts which communicate information to a selected (e.g., target) application executing within an operating system (OS) of a processor-based system. Commands may be customizable to send any suitable input information. The GUI may have multiple elements, including a toolbar user interface (UI) and/or a command editor. The GUI platform may allow users to build, share, and use automation commands. Analytics data may be collected locally and/or remotely. Local, network, and/or cloud resources may be used to backup and share commands, as well as to push notifications of updates and other valuable communications that could help the user. The system may enable and facilitate social sharing of automation commands and algorithms.

### BACKGROUND

### Technical Field

This disclosure relates to systems and methods for providing an improved user interface. More specifically, the disclosed implementations relate to graphical user interfaces providing time-saving and operation-streamlining functionality for existing target applications.

### Description of the Related Art

Software use is becoming more and more a part of everyday life. Often there are repetitive processes and workflows that can save tremendous amounts of time if automated or consolidated. Thus far, automation solutions are complex and do not have integrated analytic services or network-based sharing and/or ranking of automation algorithms (e.g., those that may save a user the most time).

Many existing applications are cumbersome, mentally intensive, and slow to learn and use. One such application type is electronic medical record (EMR) programs. EMR application use is slow and difficult at best. In some such programs, there can be up to 125 clickable items on the screen at a time, even for a “simple” routine office visit. End users have diverse needs based on specialty, practice style, and unique clinic work flows. EMR applications are difficult to customize, and have become a “one-size-fits-no-one” solution. Frustration, lost productivity, and mistakes are common. A need exists for individualized solutions that allow physicians and other users to work in the way that makes most sense to them.

### BRIEF SUMMARY

A method of operating a processor-based system to provide a simplified interface for a target application which executes on the processor-based system may be summarized as including storing, by at least one processor of the processor-based system on at least one nontransitory processor-readable storage medium communicatively coupled to the at least one processor, a scripted macro command corresponding to a plurality of actions relating to the target application; generating, by the at least one processor, a graphical user interface (GUI) having at least one interactive element, the GUI viewable on a display of the processor-based system concurrently with an active GUI of the target application; associating, by the at least one processor, the at least one interactive element with the macro command; receiving, by the at least one processor, an activation of the interactive element; and responsive to receiving the activation of the at least one interactive element, executing, by the at least one processor, the macro command to cause execution of the plurality of actions relating to the target application.

The method may further include receiving, by the at least one processor, a modified version of the macro command via a command editor interface; storing, by the at least one processor, the modified version of the macro command on the at least one nontransitory processor-readable storage medium; and regenerating, by the at least one processor, the GUI to include the modified version of the macro command.

The method may further include receiving, by the at least one processor, a new macro command via a command editor interface; storing, by the at least one processor, the new macro command on the at least one nontransitory processor-readable storage medium; and regenerating, by the at least one processor, the GUI to include the new macro command.

The method may further include monitoring, by the at least one processor, execution of the macro command over a period of time; and storing, by the at least one processor, analytics data for the macro command based at least in part on the monitoring of the execution of the macro command over the period of time.

The method, wherein generating a GUI may include generating a GUI which may include an analytics interactive element, may further include receiving, by the at least one processor, an activation of the analytics interactive element; and responsive to receiving the activation of the analytics interactive element, causing a display of analytics information on the display of the processor-based system, the analytics information based at least in part on the stored analytics data. Causing a display of analytics information may include causing a display of at least one of a chart, a table, or a graph. Storing analytics data for the macro command may include storing at least one of: a number of executions of the macro command during the period of time, or a cumulative amount of time saved by executing the macro command during the period of time.

The method may further include evaluating, by the at least one processor, the analytics data for the macro command; and responsive to evaluating the analytics data for the macro command, providing, by the at least one processor, a suggestion message viewable on the display of the processor-based system, the suggestion message relating to at least one of: a suggestion to modify the macro command, or a suggestion to utilize another macro command. Storing the macro command may include storing the macro command in the at least one nontransitory processor-readable storage medium, and the macro command may include at least one of: a keyboard command, a mouse command, a sub-macro command, a delay period, an application programming interface (API) command, or an operating system command.

The method may further include monitoring, by the at least one processor, a state of the target application; determining, by the at least one processor, whether the macro command can be executed based at least in part on the state of the target application; responsive to determining the macro command can be executed based at least in part on the state of the target application, enabling the at least one interactive element for activation; and responsive to determining the macro command cannot be executed based at least in part on the state of the target application, disabling the at least one interactive element for activation.

A processor-based system to provide a simplified interface for a target application which executes on the processor-based system may be summarized as including at least one nontransitory processor-readable storage medium that stores at least one of processor-executable instructions or data; and at least one processor communicably coupled to the at least one nontransitory processor-readable storage medium, in operation the at least one processor: stores a scripted macro command corresponding to a plurality of actions relating to the target application on the at least one nontransitory processor-readable storage medium; generates a graphical user interface (GUI) having at least one interactive element, the GUI viewable on a display of the processor-based system concurrently with an active GUI of the target application; associates the at least one interactive element with the macro command; receives an activation of the interactive element; and responsive to receipt of the activation of the at least one interactive element, executes the macro command to cause execution of the plurality of actions relating to the target application. The at least one processor may receive a modified version of the macro command via a command editor interface; store the modified version of the macro command on the at least one nontransitory processor-readable storage medium; and regenerate the GUI to include the modified version of the macro command. The at least one processor may receive a new macro command via a command editor interface; store the new macro command on the at least one nontransitory processor-readable storage medium; and regenerate the GUI to include the new macro command. The at least one processor may monitor execution of the macro command over a period of time; and store analytics data for the macro command on the at least one nontransitory processor-readable storage medium based at least in part on the monitoring of the execution of the macro command over the period of time. The at least one processor may generate a GUI which includes an analytics interactive element; receive an activation of the analytics interactive element; and, responsive to receipt of the activation of the analytics interactive element, cause a display of analytics information on the display of the processor-based system, the analytics information based at least in part on the stored analytics data. The at least one processor may cause a display of at least one of a chart, a table, or a graph. The at least one processor may store at least one of: a number of executions of the macro command during the period of time, or a cumulative amount of time saved by executing the macro command during the period of time. The at least one processor may evaluate the analytics data for the macro command; and, responsive to the evaluation of the analytics data for the macro command, provide a suggestion message viewable on the display of the processor-based system, the suggestion message relating to at least one of: a suggestion to modify the macro command, or a suggestion to utilize another macro command. The macro command may include at least one of: a keyboard command, a mouse command, a sub-macro command, a delay period, an application programming interface (API) command, or an operating system command. The at least one processor may monitor a state of the target application; determine whether the macro command can be executed based at least in part on the state of the target application; responsive to a determination that the macro command can be executed based at least in part on the state of the target application, enable the at least one interactive element for activation; and, responsive to a determination that the macro command cannot be executed based at least in part on the state of the target application, disable the at least one interactive element for activation.

A method of sharing user-generated macro commands associated with a target software application may be summarized as including storing, by at least one processor, a plurality of macro commands on at least one nontransitory processor-readable storage medium, the at least one nontransitory processor-readable storage medium accessible by a plurality of processor-based devices associated with a plurality respective users via at least one data communications network; organizing the plurality of macro commands according to one or more criteria; presenting a visual representation of at least a portion of the organized macro commands to a processor-based device associated with a user, the visual presentation based at least in part on the organizing of the plurality of macro commands; receiving, by the at least one processor, a selection of one of the organized macro commands from the processor-based device associated with the user; and providing, by the at least one processor, the selected one of the organized macro commands to the processor-based device associated with the user via the at least one data communications network. Organizing the plurality of macro commands may include ranking the plurality of macro commands according to one or more criteria. Ranking the plurality of macro commands may include ranking the plurality of macro commands based at least in part on: a detected frequency of use of each of the macro commands, or a user rating of each of the macro commands. Organizing the plurality of macro commands may include organizing the plurality of macro commands based at least in part on a nested hierarchy of categories and sub-categories. Organizing the plurality of macro commands may include organizing the plurality of macro commands based at least in part on: a user type, an organizational unit, an operating system type, or a target application type.

A processor-based system to share user-generated macro commands associated with a target software application may be summarized as including at least one nontransitory processor-readable storage medium that stores at least one of processor-executable instructions or data; and at least one processor communicably coupled to the at least one nontransitory processor-readable storage medium, in operation the at least one processor: stores a plurality of macro commands on the at least one nontransitory processor-readable storage medium, the at least one nontransitory processor-readable storage medium accessible by a plurality of processor-based devices associated with a plurality respective users via at least one data communications network; organizes the plurality of macro commands according to one or more criteria; presents a visual representation of at least a portion of the organized macro commands to a processor-based device associated with a user, the visual presentation based at least in part on the organizing of the plurality of macro commands; receives a selection of one of the organized macro commands from the processor-based device associated with the user; and provides the selected one of the organized macro commands to the processor-based device associated with the user via the at least one data communications network. The at least one processor may rank the plurality of macro commands according to one or more criteria. The at least one processor may rank the plurality of macro commands based at least in part on: a detected frequency of use of each of the macro commands, or a user rating of each of the macro commands. The at least one processor may organize the plurality of macro commands based at least in part on a nested hierarchy of categories and sub-categories. The at least one processor may organize the plurality of macro commands based at least in part on: a user type, an organizational unit, an operating system type, or a target application type.

A method of operating a processor-based system to provide a simplified interface for a target application which executes on the processor-based system may be summarized as including monitoring, by at least one processor of the processor-based system, a plurality of actions within a graphical user interface (GUI) of the target application over a period of time; autonomously identifying, by the at least one processor, at least one pattern of actions in the plurality of actions, the pattern comprising at least two actions relating to the target application; autonomously generating, by the at least one processor, a macro command corresponding to the at least two actions in the pattern of actions relating to the target application; storing, by at least one processor on at least one nontransitory processor-readable storage medium communicatively coupled to the at least one processor, the generated macro command; generating, by the at least one processor, a GUI having at least one interactive element, the GUI viewable on a display of the processor-based system concurrently with the GUI of the target application; associating, by the at least one processor, the at least one interactive element with the macro command; receiving, by the at least one processor, an activation of the interactive element; and responsive to receiving the activation of the at least one interactive element, executing, by the at least one processor, the macro command to cause execution of the at least two actions relating to the target application. Monitoring a plurality of actions within a GUI of the target application over a period of time may include monitoring a plurality of actions executed by a single user. Monitoring a plurality of actions within a GUI of the target application over a period of time may include monitoring a plurality of actions executed by a plurality of users. Monitoring a plurality of actions within a GUI of the target application over a period of time may include monitoring at least one of: a keyboard command, a mouse command, a sub-macro command, a delay period, an application programming interface (API) command, or an operating system command. Monitoring a plurality of actions within a GUI of the target application over a period of time may include monitoring execution of a sub-macro command relating to the target application, and generating a macro command may include generating a macro command which includes the sub-macro command and at least one additional action relating to the target application.

A processor-based system to provide a simplified interface for a target application which executes on the processor-based system may be summarized as including at least one nontransitory processor-readable storage medium that stores at least one of processor-executable instructions or data; and at least one processor communicably coupled to the at least one nontransitory processor-readable storage medium, in operation the at least one processor: monitors a plurality of actions within a graphical user interface (GUI) of the target application over a period of time; autonomously identifies at least one pattern of actions in the plurality of actions, the pattern comprising at least two actions relating to the target application; autonomously generates a macro command corresponding to the at least two actions in the pattern of actions relating to the target application; stores the generated macro command on the at least one nontransitory processor-readable storage medium; generates a GUI having at least one interactive element, the GUI viewable on a display of the processor-based system concurrently with the GUI of the target application; associates the at least one interactive element with the macro command; receives an activation of the interactive element; and responsive to receipt of the activation of the at least one interactive element, executes the macro command to cause execution of the at least two actions relating to the target application. The at least one processor may monitor a plurality of actions executed by a single user. The at least one processor may monitor a plurality of actions executed by a plurality of users. The at least one processor may monitor at least one of: a keyboard command, a mouse command, a sub-macro command, a delay period, an application programming interface (API) command, or an operating system command. The at least one processor may monitor execution of a sub-macro command relating to the target application, and generating a macro command comprises generating a macro command which includes the sub-macro command and at least one additional action relating to the target application.

A method of sharing user-generated macro commands associated with a target software application may be summarized as including storing, by at least one processor, a plurality of macro commands on at least one nontransitory processor-readable storage medium; for each of the plurality of macro commands, identifying, by the at least one processor, a number of processor-based devices which utilize the macro command; modifying, by the at least one processor, at least one macro command of the plurality of macro commands; and providing, by the at least one processor, the modified macro command to each of the number of the processor-based devices identified as utilizing the macro command via at least one data communications network. Providing the modified macro command to each of the number of the processor-based devices identified as utilizing the macro command may include providing the modified macro command to each of the number of processor-based devices via the at least one data communications network without receiving a request for the modified macro command from at least one of the number of the processor-based devices. Providing the modified macro command to each of the number of the processor-based devices identified as utilizing the macro command may include providing access to the modified macro command to each of the number of processor-based devices over the at least one data communications network.

A processor-based system to share user-generated macro commands associated with a target software application may be summarized as including at least one nontransitory processor-readable storage medium that stores at least one of processor-executable instructions or data; and at least one processor communicably coupled to the at least one nontransitory processor-readable storage medium, in operation the at least one processor: stores a plurality of macro commands on at least one nontransitory processor-readable storage medium; for each of the plurality of macro commands, identifies a number of processor-based devices which utilize the macro command; modifies at least one macro command of the plurality of macro commands; and provides the modified macro command to each of the number of the processor-based devices identified as utilizing the macro command via at least one data communications network. The at least one processor may provide the modified macro command to each of the number of processor-based devices via the at least one data communications network without receipt of a request for the modified macro command from at least one of the number of the processor-based devices. The at least one processor may provide access to the modified macro command to each of the number of processor-based devices over the at least one data communications network.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a schematic diagram showing relationships between various components of an illustrative dynamic graphical user interface (GUI) platform, according to one illustrated implementation.

FIG. 2 is a schematic diagram showing relationships between various components of an illustrative dynamic GUI platform according to one illustrated implementation, as well as related program flow and conceptual layers.

FIG. 3 is a schematic diagram showing relationships between various components of an illustrative dynamic GUI platform according to one illustrated implementation, with extensive descriptions of related features.

FIG. 4 is a schematic diagram of an illustrative data processing system, according to one illustrated implementation.

FIG. 5 is a schematic diagram of an illustrative computer network, according to one illustrated implementation.

FIG. 6 is a flow diagram depicting selected acts of an illustrative method for editing and organizing command scripts, according to one illustrated implementation.

FIG. 7 is a flow diagram depicting selected acts of an illustrative method for updating a toolbar, according to one illustrated implementation.

FIG. 8 illustrates a portion of an illustrative toolbar, according to one illustrated implementation.

FIGS. 9-43 are screenshots depicting various operations of a toolbar and command builder interface, according to one illustrated implementation.

FIG. 44 is a flow diagram of a method of operation for a processor-based system to provide a simplified interface for a target application which executes on the processor-based system, according to one illustrated implementation.

FIG. 45 is a flow diagram of a method of operation for a processor-based system to dynamically update a toolbar of the simplified interface, according to one illustrated implementation.

FIG. 46 is a flow diagram of a method of operation for a processor-based system to perform analytics related to the simplified interface, according to one illustrated implementation.

FIG. 47 is a flow diagram of a method of operation for a processor-based system to provide analytics-based suggestions to a user regarding the simplified interface, according to one illustrated implementation.

FIG. 48 is a flow diagram of a method of operation for a processor-based system to dynamically alter available macro commands which are available through the simplified interface based on a state of the target application, according to one illustrated implementation.

FIG. 49 is a flow diagram of a method of operation for a processor-based system to share a plurality of macro commands with a plurality of remotely located users, according to one illustrated implementation.

FIG. 50 is a flow diagram of a method of operation for a processor-based system to autonomously generate macro commands for the simplified interface, according to one illustrated implementation.

FIG. 51 is a flow diagram of a method of operation for a processor-based system to provide updated macro commands to a plurality of processor-based devices associated with a plurality of respective users, according to one illustrated implementation.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

One or more implementations of a dynamic graphical user interface (GUI) system (also referred to herein as a platform), as well as related methods, are described below and illustrated in the associated drawings. Unless otherwise specified, a dynamic GUI system and/or its various components may, but are not required to, contain at least one of the structure, components, functionality, and/or variations described, illustrated, and/or incorporated herein. Furthermore, the process acts, structures, components, functionalities, and/or variations described, illustrated, and/or incorporated herein in connection with the present teachings may, but are not required to, be included in other similar interfaces. The following description of various implementations is merely exemplary in nature and is in no way intended to limit the disclosure, its application, or uses. Additionally, the advantages provided by the implementations, as described below, are illustrative in nature and not all implementations provide the same advantages or the same degree of advantages.

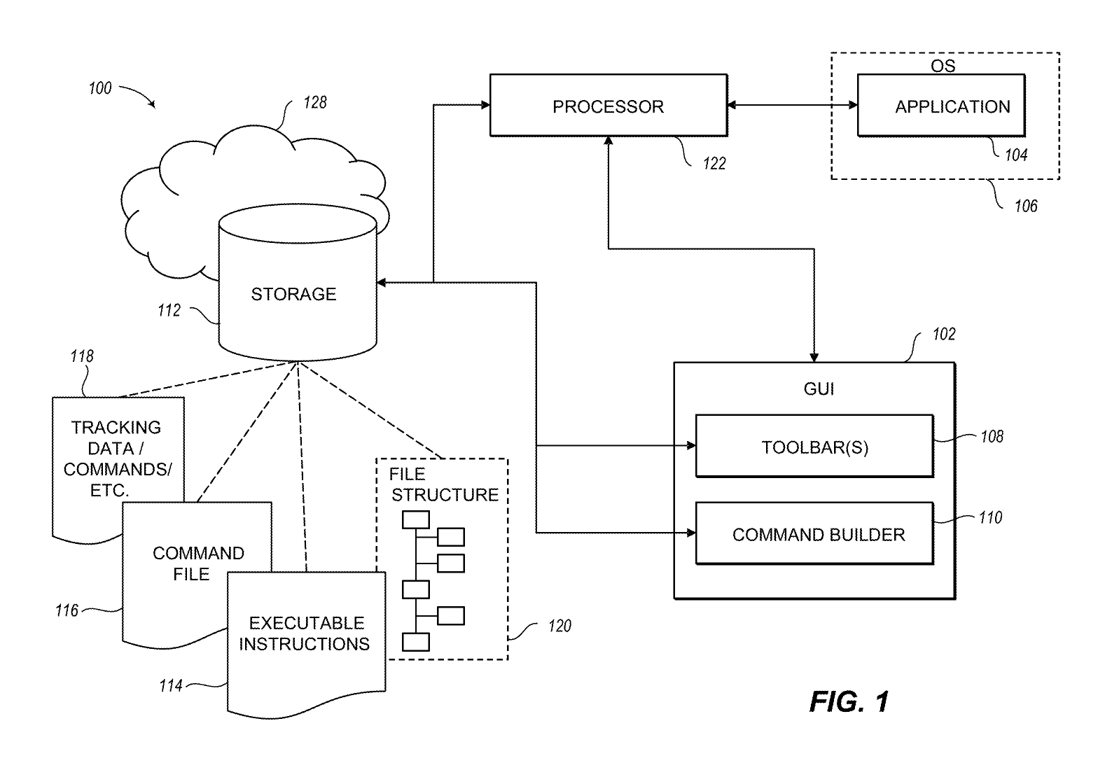

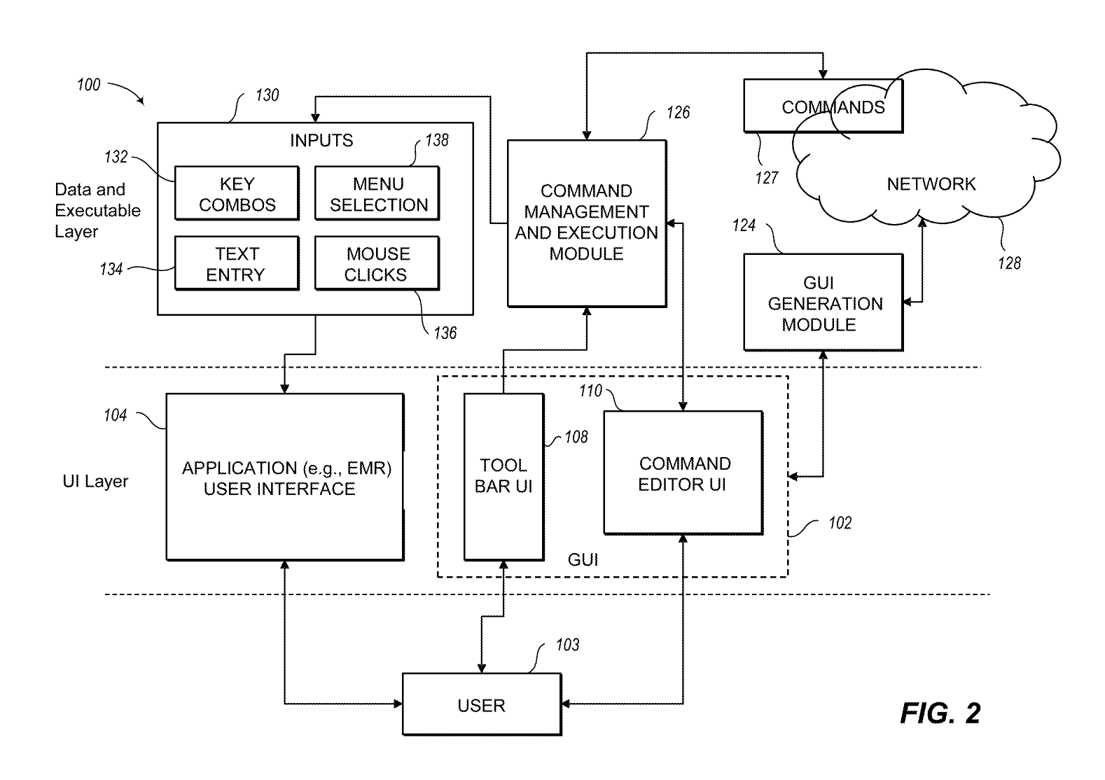

FIG. 1 is a schematic diagram showing relationships between modules and components in a dynamic GUI platform 100 in accordance with aspects of the present disclosure. FIG. 2 is a schematic diagram showing relationships between various conceptual layers, components, and interfaces within the system 100.

In general, and with reference to FIGS. 1 and 2, a dynamic GUI platform 100 may include a standalone GUI 102 configured to execute, at the request of a user 103 (FIG. 2), command scripts 127 which communicate information to a selected (e.g., target) application 104 which executes within an operating system (OS) 106. Command scripts may be customizable to send any suitable input information 130 (FIG. 2), including keystrokes 132, text 134, mouse clicks 136, menu selections 138, and/or application-specific commands, or the like, or any combination of these. The GUI 102 may have multiple elements, including a toolbar user interface (UI) 108 and/or a command editor UI 110 (also referred to herein as a command builder). These components are described in further detail below. In some implementations, the macro commands may be real-time compiled and executed on multiple platforms.

The system 100 further includes a memory or storage component 112, which may include local storage, remote storage (e.g., network storage), and/or cloud-based storage (e.g., over the Internet), or any combination of these. Information that may be stored in memory includes executable instructions 114 relating to the dynamic GUI system 100 itself, a command file 116 containing subroutines and/or scripts (some or all of which may be user-generated), analytical data 118 relating to operation and performance of the system and/or the user, a folder structure 120 for organizing relevant files, and/or examples or user-shared scripts or commands, and the like.

One or more processors 122 may be utilized to execute the stored instructions 114, to generate the dynamic GUI system 100, and to carry out the commands and scripts selected by a user. The processor 122, for example, may respond to a selection by the user 103 from the toolbar UI 108 by sending a predetermined key combination to a selected application 104 running on the operating system (OS) 106.

Accordingly, dynamic GUI platforms described herein provide a straightforward way for users to build, share, and use automation commands. The command builder 110 can be used to construct and fine-tune macro commands. Analytics data 118 may be collected locally and/or remotely. Organized custom toolbars may be provided, with designs that integrate well with the target software application 104. Local, network, and/or cloud resources may be used to backup and share commands, as well as to push notifications of updates and other valuable communications that could help the user 103. The system 100 enables and facilitates social sharing of automation commands and algorithms.

As mentioned, analytics data 118 may be collected, including how many times a macro command is used, how long it takes to execute a macro command, an estimate of how much time it would take a human to execute the same actions as the macro command, the number of acts automated, and/or an estimate of how much time has been saved by using the macro command. Command contents may be stored locally and/or remotely. Instructions for key-presses, mouse-clicks, and application programming interface (API) communication with target/receiving software applications may be converted into actual communication directly with the application 104 running on the OS 106 of the system.

Aspects of the dynamic GUI platform 100 may be embodied as a computer method, computer system, or computer program product. Accordingly, aspects of the platform 100 may take the form of an entirely hardware implementation, an entirely software implementation (including firmware, resident software, micro-code, and the like), or an implementation combining software and hardware aspects, all of which may generally be referred to herein as a “circuit,” “module,” or “system.” Furthermore, aspects of the dynamic GUI system 100 may take the form of a computer program product embodied in a non-transitory computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or any suitable combination of these and/or the like. In the context of this disclosure, a computer-readable storage medium may include any suitable tangible medium that can contain or store a program for use by or in connection with an instruction execution system, apparatus, or device.

Program code embodied on a computer-readable medium may be transmitted using any appropriate medium, including but not limited to wireless, wireline, optical fiber cable, RF, and/or the like, and/or any suitable combination of these.

Computer program code for carrying out operations for aspects of the dynamic GUI platform 100 may be written in one or any combination of programming languages, including an object-oriented programming language such as AJAX, Java, Ruby, Python, Smalltalk, C++, and/or the like, and conventional procedural programming languages, such as the C programming language. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of dynamic GUI platforms are described below with reference to flowchart illustrations and/or block diagrams of methods, apparatus, systems, and/or computer program products. Each block and/or combination of blocks in a flowchart and/or block diagram may be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer-readable medium that can direct a computer, other programmable data processing apparatus, and/or other device to function in a particular manner, such that the instructions stored in the computer-readable medium produce an article of manufacture including instructions which implement the function/act specified in the flowchart and/or block diagram block or blocks.

The computer program instructions can also be loaded onto a computer, other programmable data processing apparatus, and/or other device to cause a series of operational acts to be performed on the device to produce a computer-implemented process such that the instructions which execute on the computer or other programmable apparatus provide processes for implementing the functions/acts specified in the flowchart and/or block diagram block or blocks.

Any flowchart and/or block diagram in the drawings is intended to illustrate the architecture, functionality, and/or operation of possible implementations of systems, methods, and computer program products according to aspects of the present disclosure. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

The following sections describe selected aspects of exemplary dynamic GUI platforms, as well as related systems and/or methods. The examples in these sections are intended for illustration and should not be interpreted as limiting the entire scope of the present disclosure. Each section may include one or more distinct implementations, and/or contextual or related information, function, and/or structure.

The dynamic GUI platforms described herein may include software that generates, populates, and takes action based on user interaction with the graphical user interface 102 comprising the toolbar 108 and the command editor 110. Accordingly, the platform 100 may include a GUI generation module 124, a command management and execution module 126, the GUI 102 having the toolbar UI 108 and the command editor UI 110, as well as associated supporting files and data store(s). As discussed above, one or more individual portions of the platform 100 may be embodied in a computer network 128.

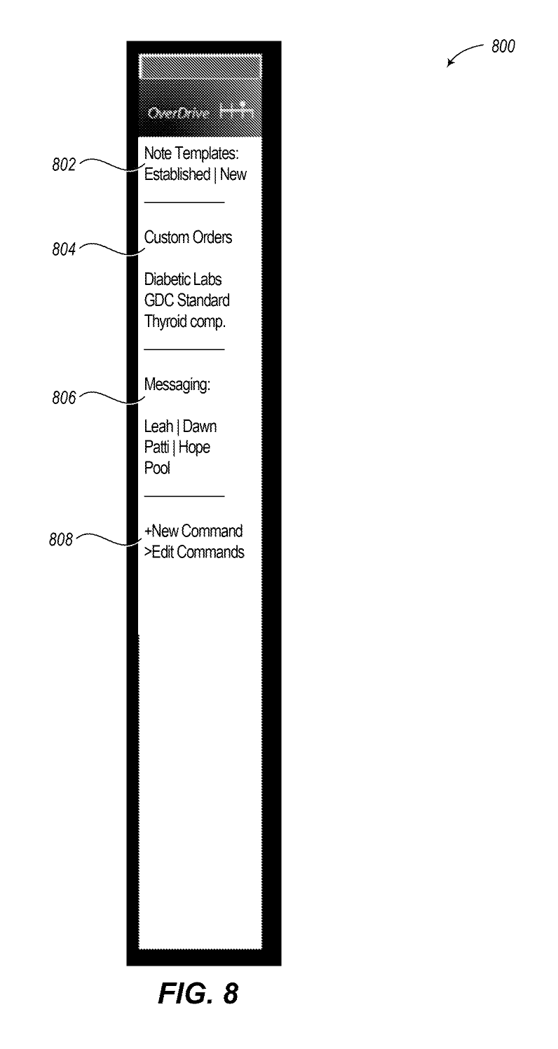

The GUI generation module 124 may include any suitable circuit or software code configured to selectively generate and display the graphical user interface 102 comprising a toolbar 108 (or the equivalent) and the command editor/builder 110. Portions of the interface 102 may be interactive, such that a user may select, click, enter, or otherwise communicate selection and desired activation of graphically represented actions. Various aspects of the GUI 102 are displayed in the illustrative screenshots of FIGS. 8-43, discussed below. In some cases, these screenshots show selection of graphical icons and/or textual representations, with resulting activity in the underlying target application.

Although a drop-down menu-style toolbar 108 is shown and described herein, commands may be organized and shown in any suitable fashion. For example, dropdown menu items, buttons, custom widgets, spinners, switches, and the like, or any combination thereof.

Each item on the toolbar UI 108 may be associated with a command or script. The commands and scripts may be predetermined, user-determined, or a combination thereof. For example, certain default scripts may be included. Additional or edited versions of those scripts may be added by the user 103 via the command builder interface 110. Selection or other activation of an item on the toolbar UI 108 may cause the command execution and management module 126 to carry out the associated action.

The command execution and management module 126 includes software code for communicating or emulating inputs 130 to the operating system 106 and/or a selected (i.e., target) application 104. This module 126 may include any suitable instructions for editing, creating, deleting, and organizing commands. For example, the command execution and management module 126 may include code that interprets scripts and sends corresponding input values and task-related actions to the target application. For example, a user-friendly scripting language may be used in the command builder 110 to communicate the actions a user wants a given command to carry out. The command execution and management module 126 may then respond to selection of that command by interpreting the script and executing the corresponding actions. This simplifies the amount of knowledge a user must have to create or modify commands. In this sense, the script carried out by the command execution and management module 126 may be considered a macroinstruction or “macro.”

The command execution and management module 126 may handle enforcement rules for command naming. This module 126 may also be configured to link toolbar items to the corresponding command scripts. The command execution and management module 126 may enable dynamic customization of the toolbar 108 (as shown in the screenshots). This may be carried out in some implementations by receiving user edits, regenerating the overall collection of scripts, closing the toolbar 108, then automatically reopening the toolbar and populating it with the revised collection of scripts.

Organization of the toolbar 108 may be handled by the command execution and management module 126, via the command builder interface 110. For example, the commands may be arranged according to user input (i.e., manually), alphabetically, by frequency of use, by rank, by rating, by category, by user, or any other suitable rubric, or any combination of these. Alternatively, each command script may be saved in a folder structure, and the toolbar arrangement may be mapped to the underlying folder structure.

Analytics may be collected by the platform 100, locally and/or remotely. Analytics may include counts of command executions, durations of commands, calculation of expected durations of corresponding actions if carried out without the platform in place, etc.

Scripts and commands may be stored locally and/or remotely (e.g., in a data store such as a database). The platform 100 may include a sharing architecture, such that a user may make selected scripts public with respect to some or the entire network. Accordingly, users on the same network (e.g., Internet, corporate intranet) may view and take advantage of each other's scripts. Popular, useful, efficient, and/or categorized scripts may be made available by the system, such as in a curated format. Commands submitted by users may be searchable by other users. Users may be allowed to vote and/or comment on scripts to enable ranking and feedback. Alternatively, scripts may be made private and/or password protected. In some implementations, the format of a macro may be specified so that the macro can be cataloged and searched. For example, the following may be specified: OS, target application, version number, last update, user type, organizational unit, etc.

The platform 100 may be used to communicate information, such as sending suggestions, tips, popular scripts, or other system-related information to one or more users. Analytics may be communicated locally and/or network-wide. For example, the GUI 102 may display a total estimated time saved, frequency of command use, etc., for a specific user and/or for one or more groups of users.

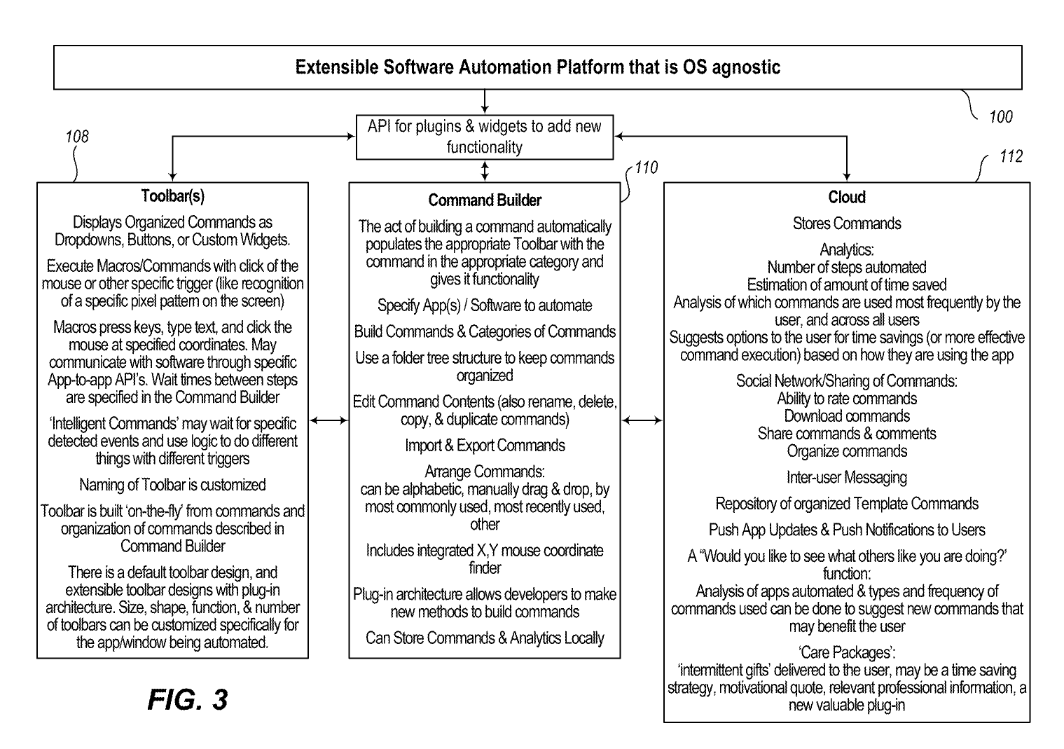

FIG. 3 shows various features or functions of the toolbar 108, the command builder 110 and the data server/storage 112 of the GUI platform 100. In particular, the toolbar 108 may: display organized commands as drop down menus, buttons or custom widgets, and may execute macros/commands with a mouse click or other specified trigger (e.g., recognition of a specific pixel pattern on a display). Macros may press keys, type text, wait specified times between actions, and click a mouse at specified coordinates. Macros may also communicate with software through specific “app-to-app” APIs. Intelligent commands may wait for specified directed events and use logic to perform different acts with different triggers.

The naming of the toolbar 108 may be customized. In some implementations, the toolbar 108 may be built “on-the-fly” from commands and organization of commands which are described in the command builder UI 110. In some implementations, there may be a default design for the toolbar 108 with plug-in architecture. The size, shape, function and number of toolbars may be customized specifically for the application or window which is being automated.

The command builder 110 may be used to perform the act of building a macro command, and may automatically populate the appropriate toolbar 108 with the command in the appropriate category, giving the command appropriate functionality. The command builder 110 may also specify which applications to automate. In some implementations, the command builder 110 utilizes a folder tree structure to organize the macro commands. The command builder 110 may also allow a user to edit contents of a command, to rename, delete, copy commands, and to import/export commands.

In some implementations, the command builder 110 may “record” and execution sequence performed manually by a user to generate a macro command from the recorded sequence.

The command builder 110 may also arrange the commands visually or logically according to one or more criteria, including alphabetically, most commonly used, most recently used, manually, etc. In some implementations, the command builder 110 includes an integrated X, Y mouse coordinates finder which allows the user to know specific X, Y coordinates when building a macro command. Further, in some implementations, the command builder 110 may utilize a plug-in architecture which allows developers to make new methods to build macro commands.

The data server/storage 112 stores macro commands therein. The data server/storage 112 may also monitor, analyze and/or store data related to various analytics of the system 100. For example, the data server/storage 112 may store the number of acts automated, an estimate of the amount of time saved, and an analysis of which commands are most frequently used by one user or by multiple users. The data server/storage 112 may also provide social networking features which allow sharing of commands, the ability to rate commands, the ability to download commands, the ability to share commands, the ability to share comments about the commands, inter-user messaging, and the ability to organize commands. The data server/storage 112 may include a repository of organized template commands.

The data server/storage 112 may be operative to push updates and/or notifications to users of the system 100. For example, the data server/storage 112 may allow users to see how other similar users are using the system, or may suggest new commands which may benefit a user based on an analysis of applications which have been automated, types of commands, and/or frequency with which one or more commands are executed.

In some implementations, the data server/storage 112 may send messages or “care packages” to users which may include, for example, time savings strategies, motivational quotes, relevant professional information, a new plug-in, a new macro command, etc.

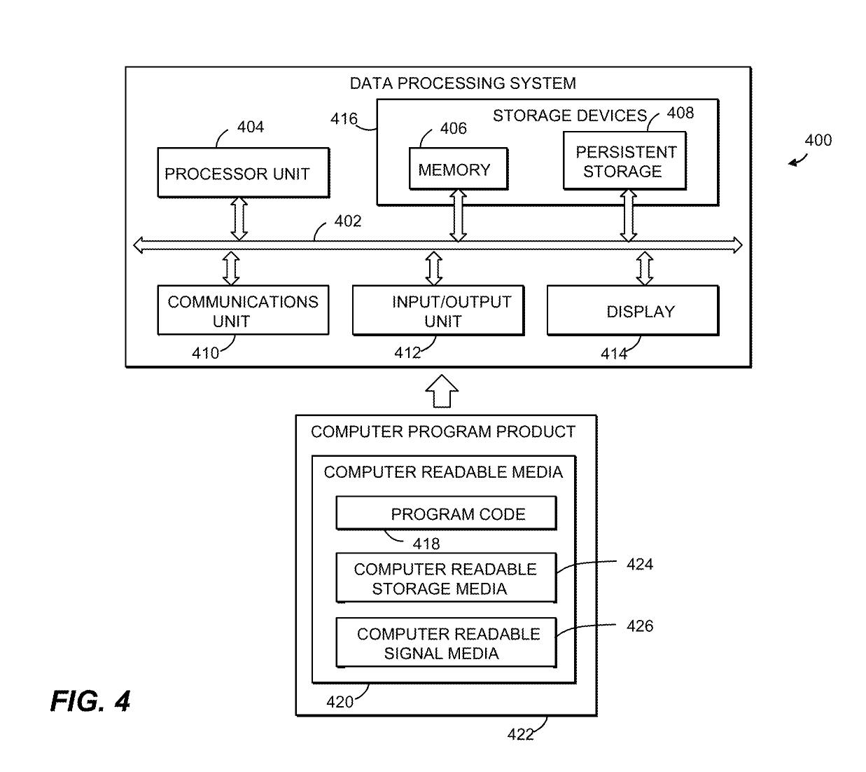

As shown in FIG. 4, this example describes a data processing system 400 (also referred to as a computer) in accordance with aspects of the present disclosure. In this example, data processing system 400 is an illustrative data processing system suitable for implementing aspects of a dynamic GUI platform, such as the ones described above. More specifically, in some examples, devices that are implementations of data processing systems (e.g., smartphones, tablets, personal computers) may incorporate aspects of a GUI, memory storage, and/or a processor included in the dynamic GUI platform.

In this illustrative example, data processing system 400 includes communications framework 402. Communications framework 402 provides communications between processor unit 404, memory 406, persistent storage 408, communications unit 410, input/output (I/O) unit 412, and display 414. Memory 406, persistent storage 408, communications unit 410, input/output (I/O) unit 412, and display 414 are examples of resources accessible by processor unit 404 via communications framework 402.

Processor unit 404 serves to run instructions that may be loaded into memory 406. Processor unit 404 may be a number of processors, a multi-processor core, or some other type of processor, depending on the particular implementation. Further, processor unit 404 may be implemented using a number of heterogeneous processor systems in which a main processor is present with secondary processors on a single chip. As another illustrative example, processor unit 404 may be a symmetric multi-processor system containing multiple processors of the same type.

Memory 406 and persistent storage 408 are examples of storage devices 416. A storage device is any piece of hardware that is capable of storing information, such as, for example, without limitation, data, program code in functional form, and other suitable information either on a temporary basis or on a permanent basis.

Storage devices 416 also may be referred to as computer-readable storage devices in these examples. Memory 406, in these examples, may be, for example, a random access memory or any other suitable volatile or non-volatile storage device. Persistent storage 408 may take various forms, depending on the particular implementation.

For example, persistent storage 408 may contain one or more components or devices. For example, persistent storage 408 may be a hard drive, a flash memory, a rewritable optical disk, a rewritable magnetic tape, or some combination of the above. The media used by persistent storage 408 also may be removable. For example, a removable hard drive may be used for persistent storage 408.

Communications unit 410, in these examples, provides for communications with other data processing systems or devices. In these examples, communications unit 410 is a network interface card. Communications unit 410 may provide communications with either or both physical and wireless communications links.

Input/output (I/O) unit 412 allows for input and output of data with other devices that may be connected to data processing system 400. For example, input/output (I/0) unit 412 may provide a connection for user input through a keyboard, a mouse, and/or some other suitable input device. Further, input/output (I/O) unit 412 may send output to a printer. Display 414 provides a mechanism to display information to a user.

Instructions for the operating system, applications, and/or programs may be located in storage devices 416, which are in communication with processor unit 404 through communications framework 402. In these illustrative examples, the instructions are in a functional form on persistent storage 408. These instructions may be loaded into memory 406 for execution by processor unit 404. The processes of the different implementations may be performed by processor unit 404 using computer-implemented instructions, which may be located in a memory, such as memory 406.

These instructions are referred to as program instructions, program code, computer usable program code, or computer-readable program code that may be read and executed by a processor in processor unit 404. The program code in the different implementations may be embodied on different physical or computer-readable storage media, such as memory 406 or persistent storage 408.

Program code 418 is located in a functional form on computer-readable media 420 that is selectively removable and may be loaded onto or transferred to data processing system 400 for execution by processor unit 404. Program code 418 and computer-readable media 420 form computer program product 422 in these examples. In one example, computer-readable media 420 may be computer-readable storage media 424 or computer-readable signal media 426.

Computer-readable storage media 424 may include, for example, an optical or magnetic disk that is inserted or placed into a drive or other device that is part of persistent storage 408 for transfer onto a storage device, such as a hard drive, that is part of persistent storage 408. Computer-readable storage media 424 also may take the form of a persistent storage, such as a hard drive, a thumb drive, or a flash memory, that is connected to data processing system 400. In some instances, computer-readable storage media 424 may not be removable from data processing system 400.

In these examples, computer-readable storage media 424 is a physical or tangible storage device used to store program code 418 rather than a medium that propagates or transmits program code 418. Computer-readable storage media 424 is also referred to as a computer-readable tangible storage device or a computer-readable physical storage device. In other words, computer-readable storage media 424 is a media that can be touched by a person.

Alternatively, program code 418 may be transferred to data processing system 400 using computer-readable signal media 426. Computer-readable signal media 426 may be, for example, a propagated data signal containing program code 418. For example, computer-readable signal media 426 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative implementations, program code 418 may be downloaded over a network to persistent storage 408 from another device or data processing system through computer-readable signal media 426 for use within data processing system 400. For instance, program code stored in a computer-readable storage medium in a server data processing system may be downloaded over a network from the server to data processing system 400. The data processing system providing program code 418 may be a server computer, a client computer, or some other device capable of storing and transmitting program code 418.

The different components illustrated for data processing system 400 are not meant to provide architectural limitations to the manner in which different implementations may be implemented. The different illustrative implementations may be implemented in a data processing system including components in addition to and/or in place of those illustrated for data processing system 400. Other components shown in FIG. 4 can be varied from the illustrative examples shown. The different implementations may be implemented using any hardware device or system capable of running program code. As one example, data processing system 400 may include organic components integrated with inorganic components and/or may be comprised entirely of organic components excluding a human being. For example, a storage device may be comprised of an organic semiconductor.

In another illustrative example, processor unit 404 may take the form of a hardware unit that has circuits that are manufactured or configured for a particular use. This type of hardware may perform operations without needing program code to be loaded into a memory from a storage device to be configured to perform the operations.

For example, when processor unit 404 takes the form of a hardware unit, processor unit 404 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a field programmable logic array, a field programmable gate array, and other suitable hardware devices. With this type of implementation, program code 418 may be omitted, because the processes for the different implementations are implemented in a hardware unit.

In still another illustrative example, processor unit 404 may be implemented using a combination of processors found in computers and hardware units. Processor unit 404 may have a number of hardware units and a number of processors that are configured to run program code 418. With this depicted example, some of the processes may be implemented in the number of hardware units, while other processes may be implemented in the number of processors.

In another example, a bus system may be used to implement communications framework 402 and may be comprised of one or more buses, such as a system bus or an input/output bus. Of course, the bus system may be implemented using any suitable type of architecture that provides for a transfer of data between different components or devices attached to the bus system.

Additionally, communications unit 410 may include a number of devices that transmit data, receive data, or both transmit and receive data. Communications unit 410 may be, for example, a modem or a network adapter, two network adapters, or some combination thereof. Further, a memory may be, for example, memory 406, or a cache, such as that found in an interface and memory controller hub that may be present in communications framework 402.

The flowcharts and block diagrams described herein illustrate the architecture, functionality, and operation of possible implementations of systems, methods, and computer program products according to various illustrative implementations. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the drawings. For example, the functions of two blocks shown in succession may be executed substantially concurrently, or the functions of the blocks may sometimes be executed in the reverse order, depending upon the functionality involved.

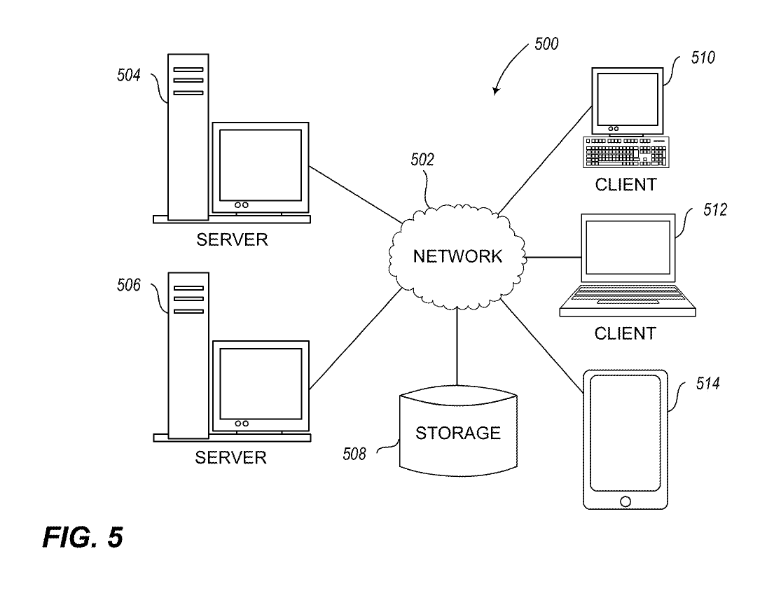

As shown in FIG. 5, this example describes a general network data processing system 500, interchangeably termed a network, a computer network, a network system, or a distributed network, in which aspects of a dynamic GUI platform may be implemented. For example, portions of the dynamic GUI platform may communicate and/or share data, scripts, commands, or other information over a network. It should be appreciated that FIG. 5 is provided as an illustration of one implementation and is not intended to imply any limitation with regard to environments in which different implementations may be implemented. Many modifications to the depicted environment may be made.

Network data processing system 500 is a network of computers, each of which is an example of data processing system 300, and other components. Network data processing system 500 may include network 502, which is a medium configured to provide communications links between various devices and computers connected together within network data processing system 500. Network 502 may include connections such as wired or wireless communication links, fiber optic cables, and/or any other suitable medium for transmitting and/or communicating data between network devices, or any combination thereof.

In the depicted example, a first network device 504 and a second network device 506 connect to network 502, as does an electronic storage device 508. Network devices 504 and 506 are each examples of data processing system 300, described above. In the depicted example, devices 504 and 506 are shown as server computers. However, network devices may include, without limitation, one or more personal computers, mobile computing devices such as personal digital assistants (PDAs), tablets, and smart phones, handheld gaming devices, wearable devices, tablet computers, routers, switches, voice gates, servers, electronic storage devices, imaging devices, and/or other networked-enabled tools that may perform a mechanical or other function. These network devices may be interconnected through wired, wireless, optical, and other appropriate communication links.

In addition, client electronic devices, such as a client computer 510, a client laptop or tablet 512, and/or a client smart device 514, may connect to network 502. Each of these devices is an example of data processing system 300, described above regarding FIG. 1. Client electronic devices 510, 512, and 514 may include, for example, one or more personal computers, network computers, and/or mobile computing devices such as personal digital assistants (PDAs), smart phones, handheld gaming devices, wearable devices, and/or tablet computers, and the like. In the depicted example, server 504 provides information, such as boot files, operating system images, and applications to one or more of client electronic devices 510, 512, and 514. Client electronic devices 510, 512, and 514 may be referred to as “clients” with respect to a server such as server computer 504. Network data processing system 500 may include more or fewer servers and clients or no servers or clients, as well as other devices not shown.

Client smart device 514 may include any suitable portable electronic device capable of wireless communications and execution of software, such as a smartphone or a tablet. Generally speaking, the term “smartphone” may describe any suitable portable electronic device having more advanced computing ability and network connectivity than a typical mobile phone. In addition to making phone calls (e.g., over a cellular network), smartphones may be capable of sending and receiving emails, texts, and multimedia messages, accessing the Internet, and/or functioning as a web browser. Smart devices (e.g., smartphones) may also include features of other known electronic devices, such as a media player, personal digital assistant, digital camera, video camera, and/or global positioning system. Smart devices (e.g., smartphones) may be capable of connecting with other smart devices, computers, or electronic devices wirelessly, such as through near field communications (NFC), BLUETOOTH®, WiFi, or mobile broadband networks. Wireless connectively may be established among smart devices, smartphones, computers, and other devices to form a mobile network where information can be exchanged.

Program code located in system 500 may be stored in or on a computer recordable storage medium, such as persistent storage 308, and may be downloaded to a data processing system or other device for use. For example, program code may be stored on a computer recordable storage medium on server computer 504 and downloaded for use to client 510 over network 502 for use on client 510.

Network data processing system 500 may be implemented as one or more of a number of different types of networks. For example, system 500 may include an intranet, a local area network (LAN), a wide area network (WAN), or a personal area network (PAN). In some examples, network data processing system 500 includes the Internet, with network 502 representing a worldwide collection of networks and gateways that use the transmission control protocol/Internet protocol (TCP/IP) suite of protocols to communicate with one another. At the heart of the Internet is a backbone of high-speed data communication lines between major nodes or host computers. Thousands of commercial, governmental, educational and other computer systems may be utilized to route data and messages. FIG. 5 is intended as an example, and not as an architectural limitation for any illustrative implementations.

The sections below describe methods relating to command editing and toolbar generation. Aspects of dynamic GUI platforms described above may be utilized in the method acts described below. Where appropriate, reference may be made to previously described components and systems that may be used in carrying out each act. These references are for illustration, and are not intended to limit the possible ways of carrying out any particular act of the method.

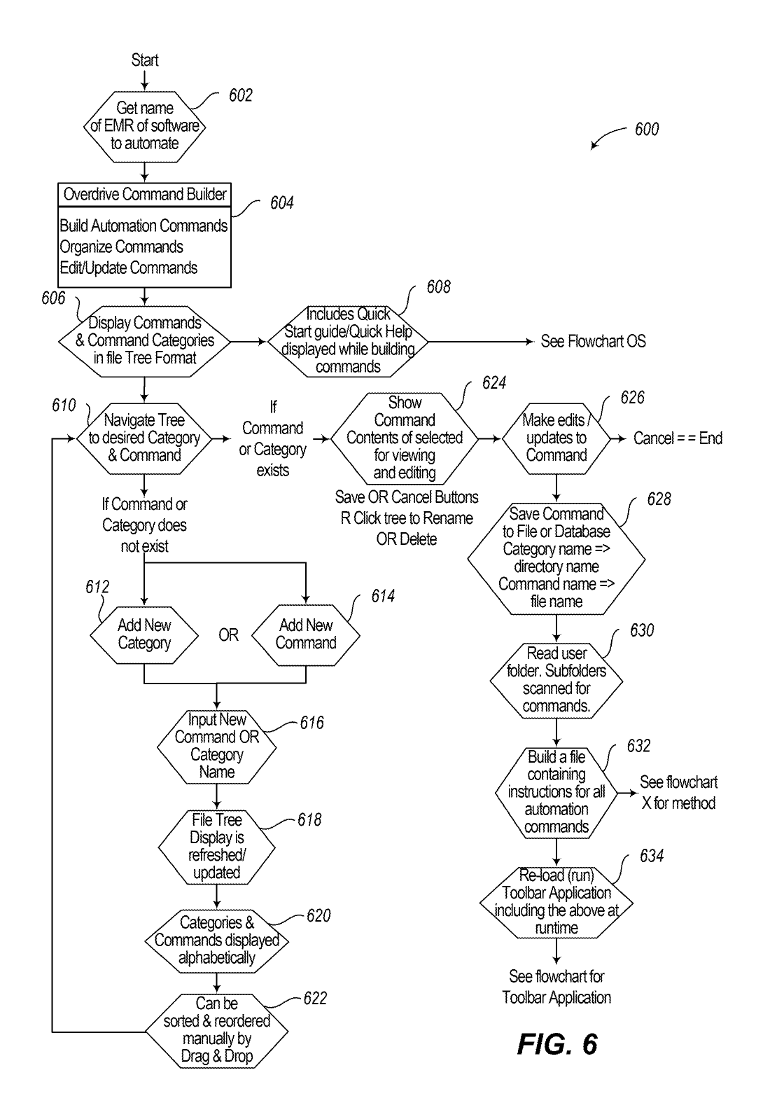

FIG. 6 is a flow diagram depicting selected acts of an illustrative method 600 for editing and organizing command scripts. The method begins at 602 where the GUI platform may obtain the name of an application, such as an EMR application, to automate. At 604, a user may utilize the command builder to build automation commands, organize the commands, and/or edit and update commands. At 606, the command builder may display the commands and command categories in a file tree format, for example. At 608, the command builder may provide a quick start guide or tutorial to the user. In some implementations, the command builder may persistently display a “quick help” section to assist the user during building of one or more commands.

At 610, the user may navigate a tree of commands and categories of commands to a desired category and command. If a particular command or category does not yet exist, at 612 the user may add a new category or at 614 the user may add a new command. At 616, the user may input a name for the new command or new category. At 618, the command builder may refresh the file tree display to reflect the new command and/or new category. At 620, the command builder may display the categories and commands in an order organized according to certain criteria (e.g., alphabetically, ranking, frequency of use). At 622, the user may manually sort and/or reorder the categories or commands using “drag and drop,” for example.

If the command or category already exists, at 624 the command builder may show the contents of a selected command for viewing and/or editing by the user. The command builder may include one or more interactive elements (e.g., buttons) which allow the user to save, cancel, rename, or delete a command. At 626, the user may make edits to one or more commands. At 628, the command builder may save the command to a file or database. In some implementations, category names may be mapped to directory names and command names may be mapped to file names.

At 630, the command builder may scan a user folder and subfolders for commands. At 632, the command builder may build a file containing instructions for all of the automation commands. At 634, the command builder may re-load (or run) the toolbar application (e.g., toolbar 108) at runtime.

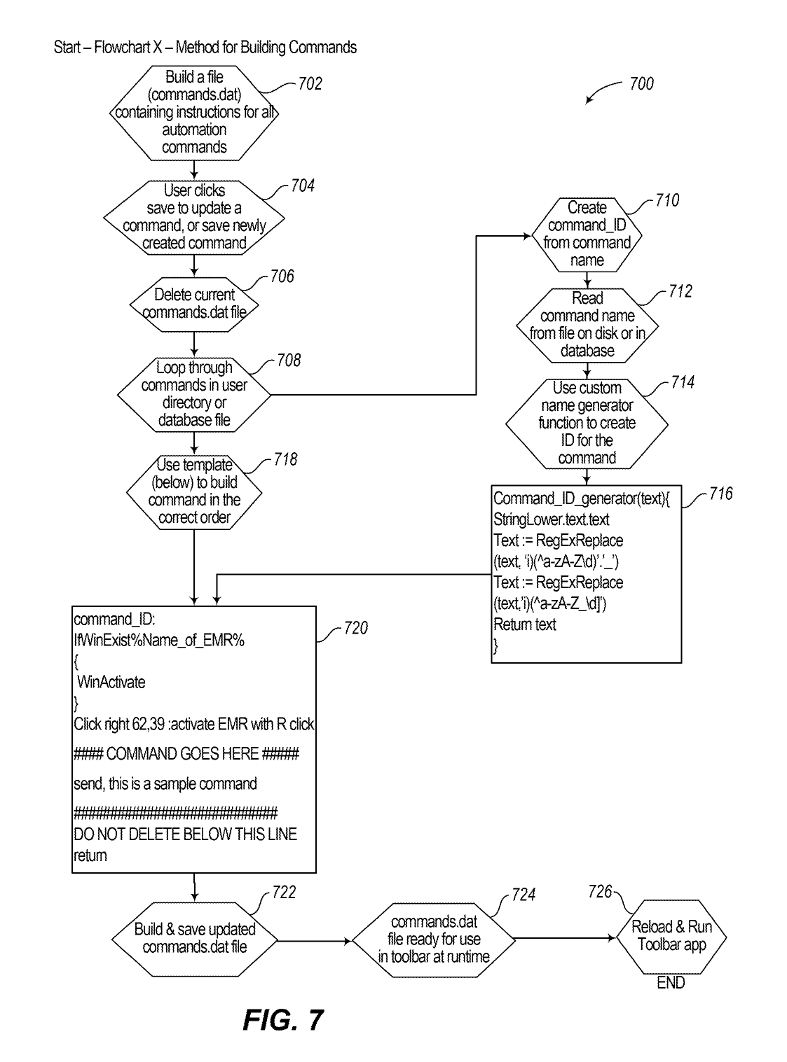

FIG. 7 is a flow diagram depicting selected acts of an illustrative method 700 for updating a toolbar, such as the toolbar 108 discussed above. The method begins at 702 where the command builder builds a file (e.g., “commands.dat”) which contains instructions for all automation commands. At 704, the user may select “save” to update a command or to save a newly created command. At 706, the command builder may delete the current commands.dat file. At 708, the command builder may loop through commands in the user's directory or database file. At 710, the command builder may create a command ID from the command name. At 712, the command builder may read the command name from a file stored in a data storage. At 714, the command builder may utilize a command name generator function to create an identifier (ID) for the command. Block 716 shows an example of such a command name generator function.

At 718, the command builder may utilize a template, such as a template shown at block 720, to build a command in the correct order. At 722, the command builder may build and save the updated commands.dat file for the user. At 724, the command builder may make the commands.dat file ready for use in the toolbar during runtime. At 726, the command builder may reload and run the toolbar application.

FIG. 8 shows a screenshot 800 of an example toolbar UI for a GUI platform, such as the GUI platforms discussed above. The toolbar includes a note templates section 802, a custom orders section 804, a messaging section 806, and a new/edit commands section 808.

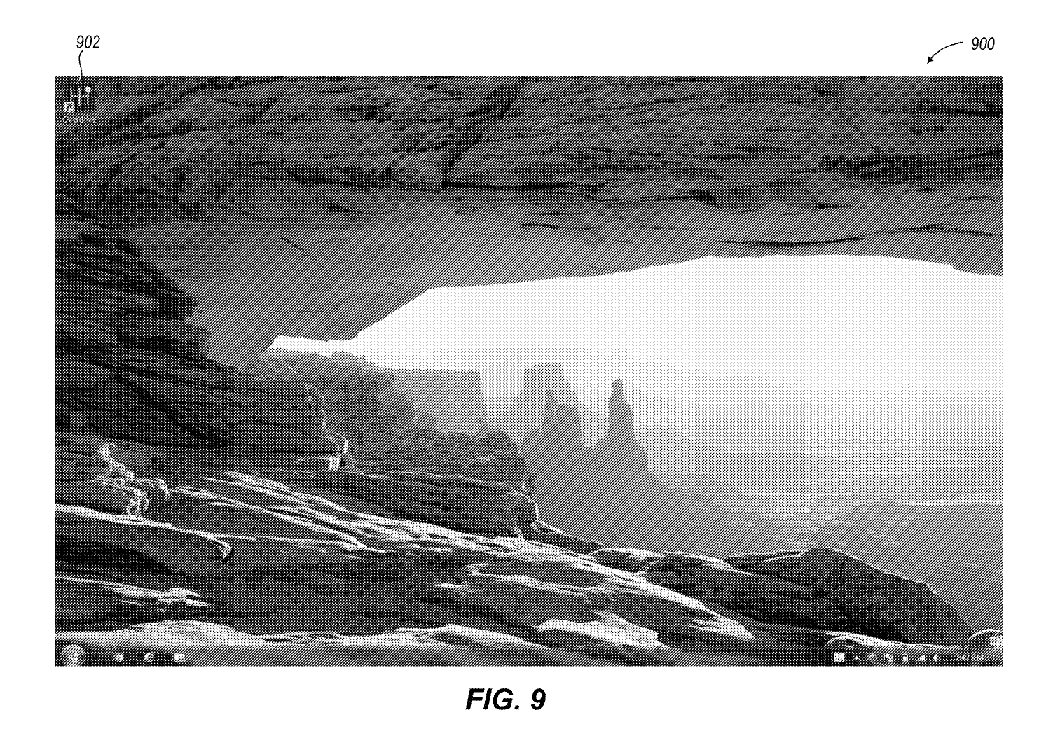

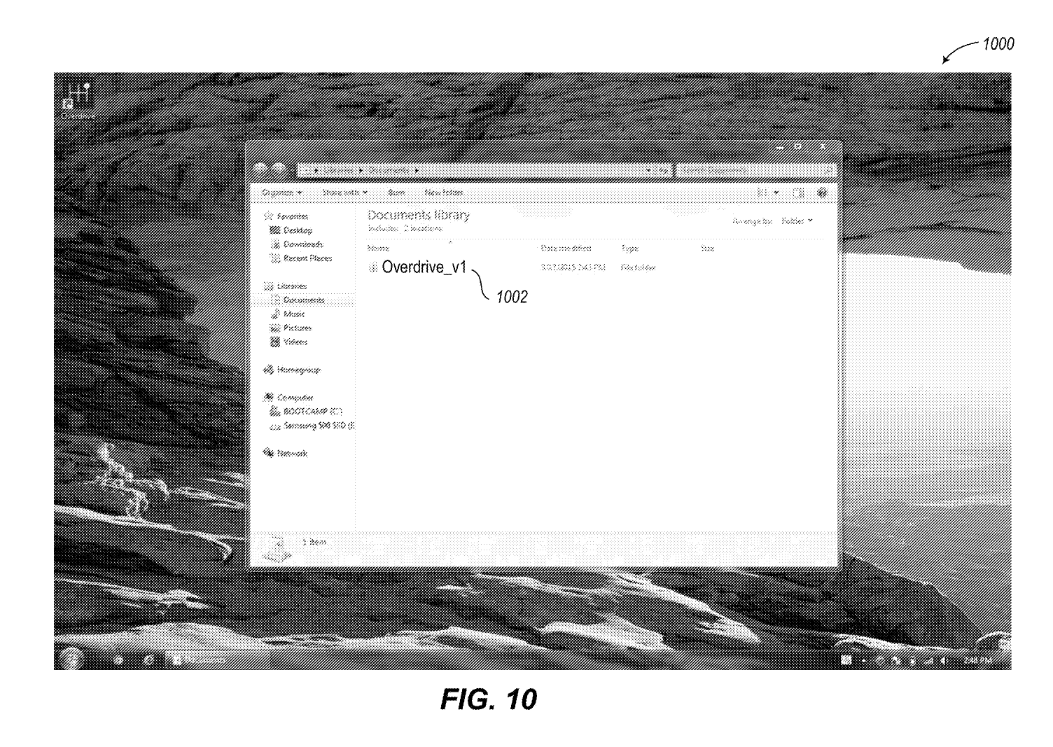

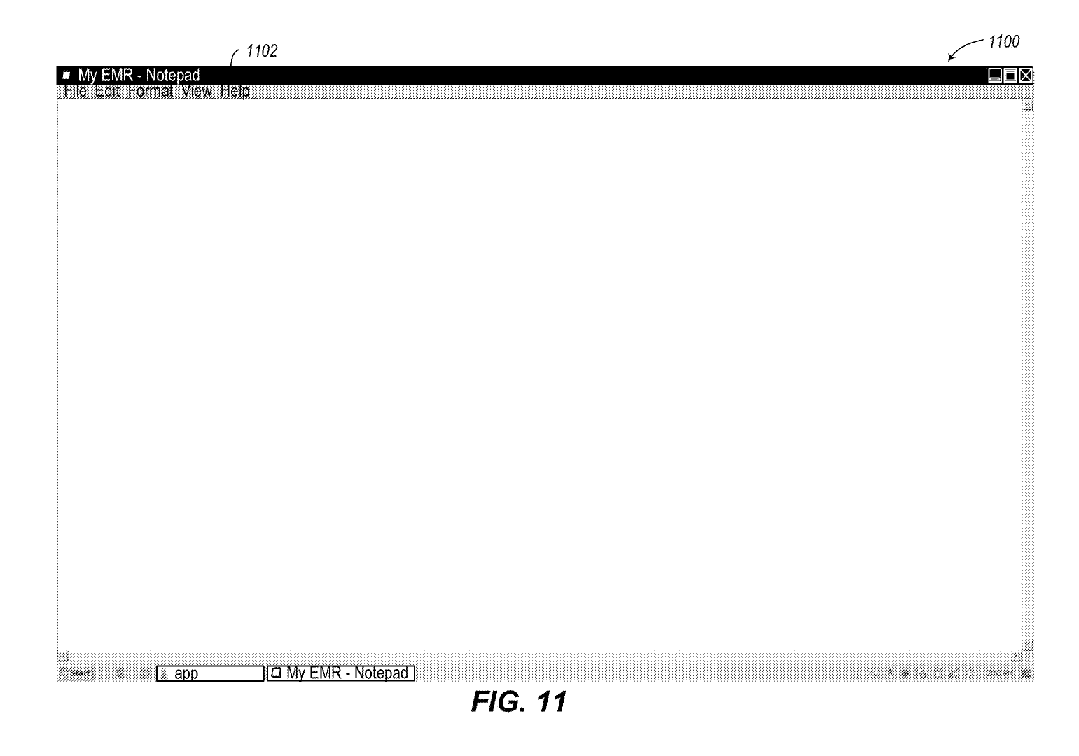

FIG. 9 shows a screenshot 900 which shows an application icon 902 of a GUI platform displayed on a display of a client computing device. FIG. 10 shows a screenshot 1000 which illustrates a location of file structures 1002 associated with the GUI platform. FIG. 11 shows a screenshot 1100 of an illustrative target application 1102. In the illustrated example, the target application 1102 is Microsoft Notepad, but in other implementations the target application may be one or more other applications (e.g., EMR application).

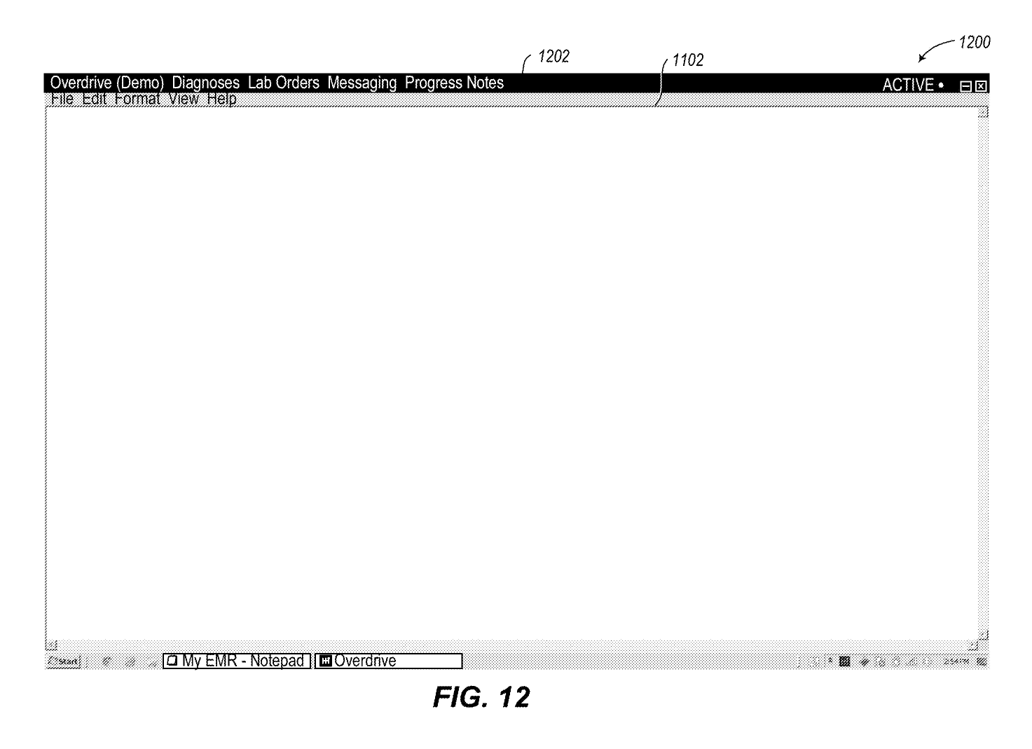

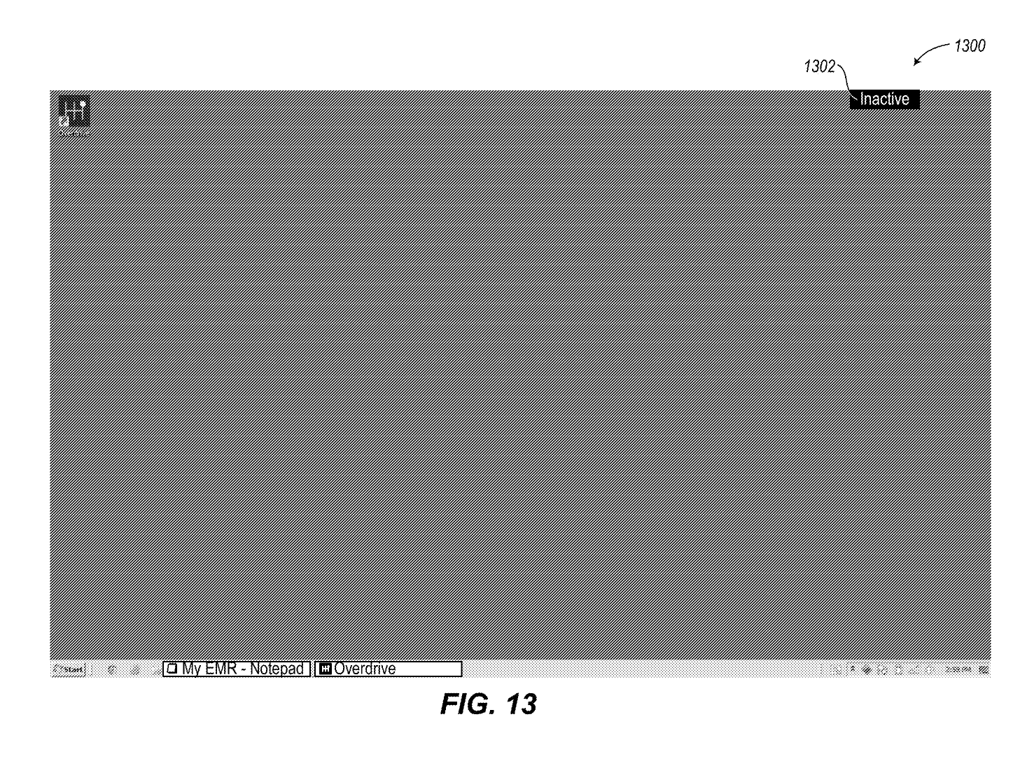

FIG. 12 shows a screenshot 1200 of a toolbar 1202 of the GUI platform which overlays the target application 1102. As shown, the toolbar 1202 is viewable concurrently with the target application 1102 without covering the active area of the target application. In some implementations, the toolbar 1202 is “always on top” so the user can at all times access the toolbar. FIG. 13 shows a screenshot 1300 which shows an icon 1302 of the toolbar 1202 when minimized.

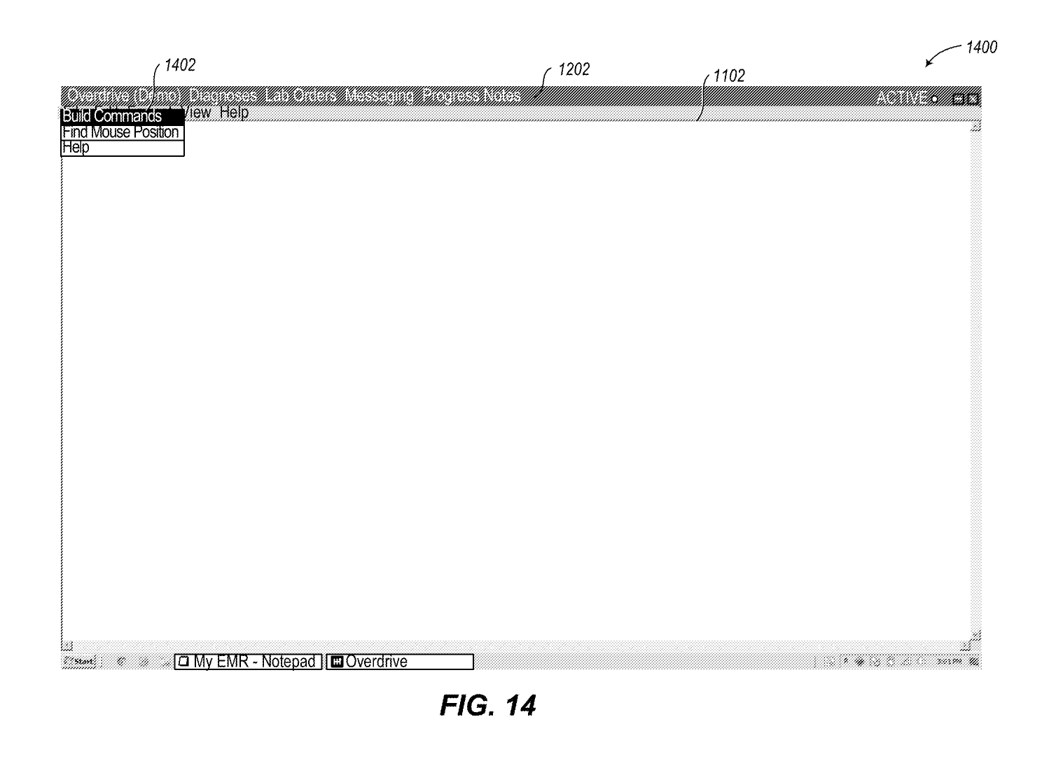

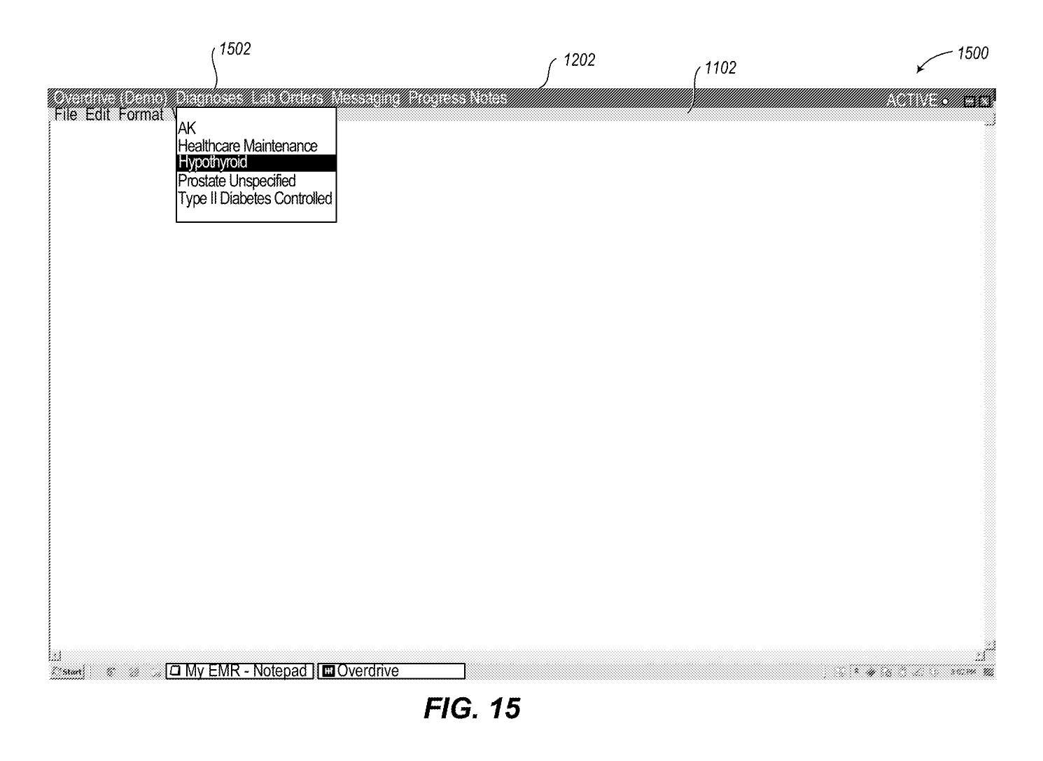

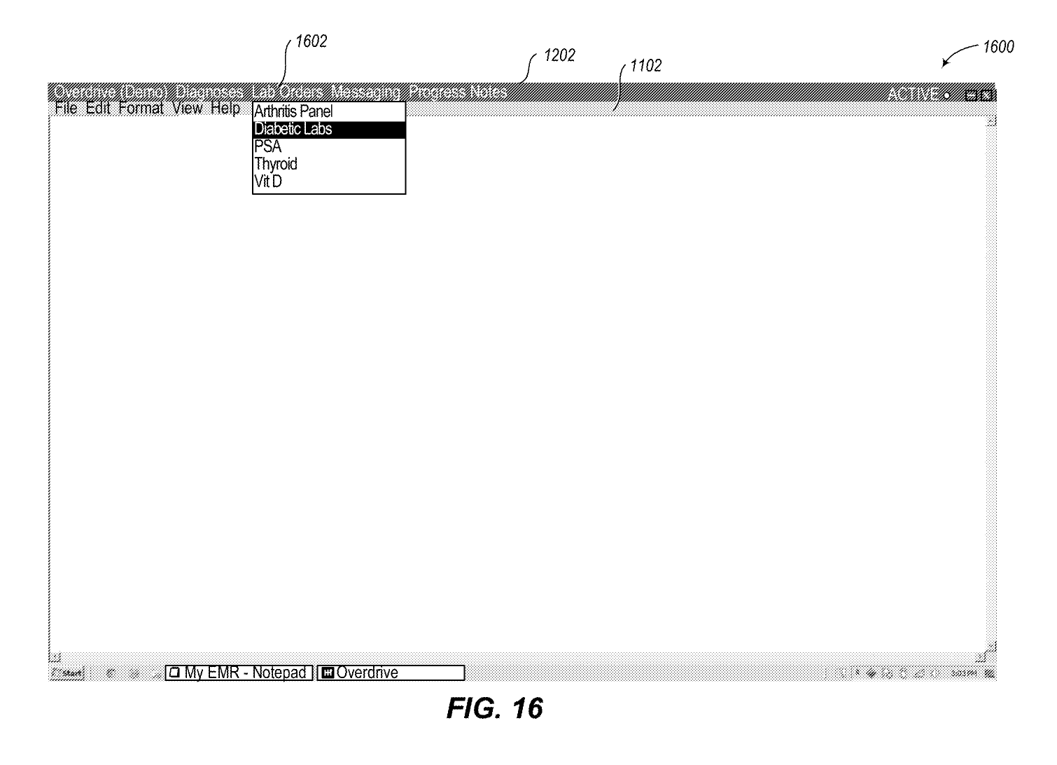

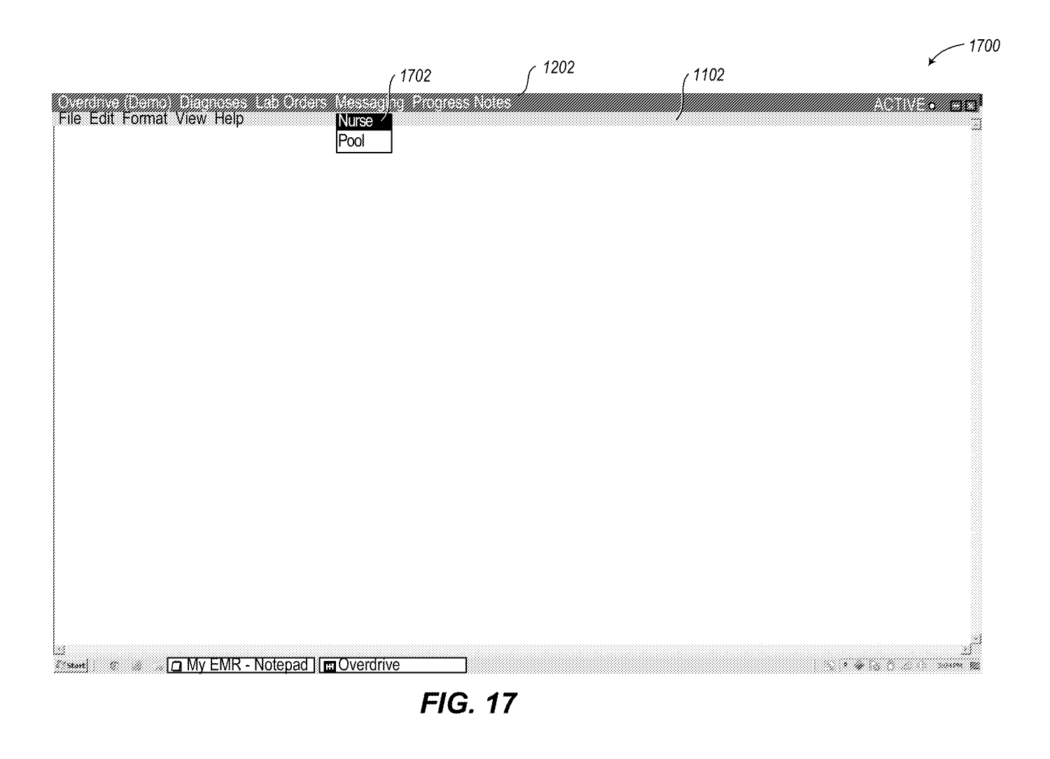

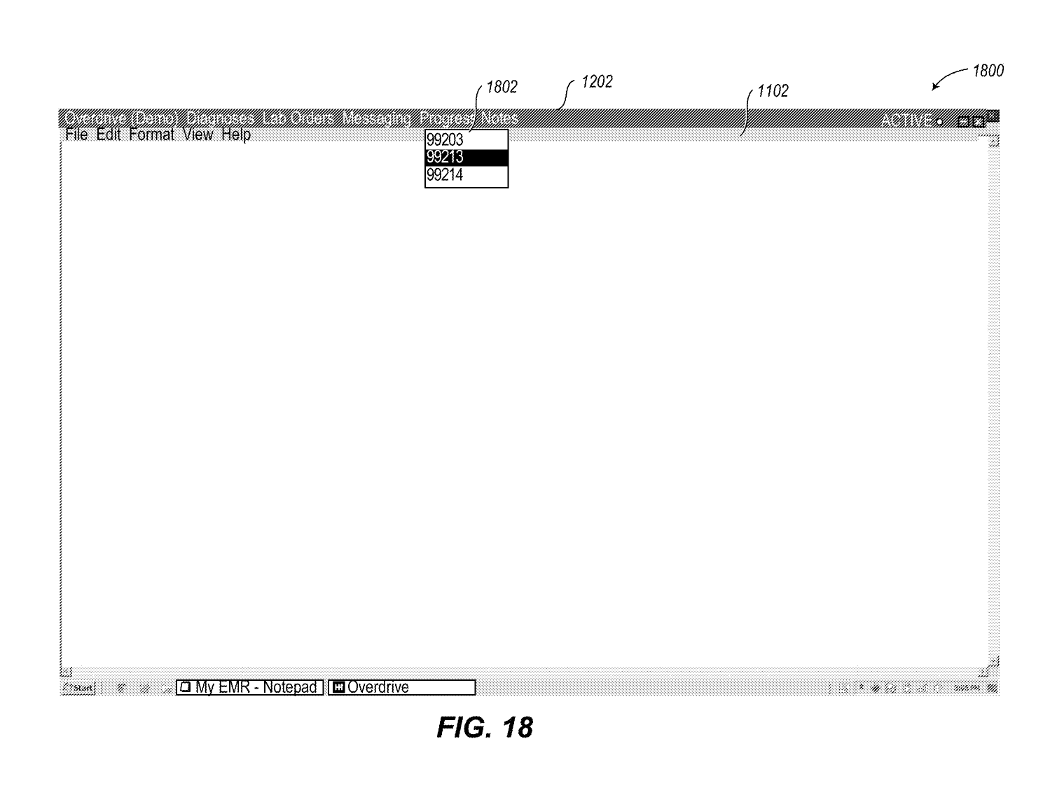

FIG. 14 shows a screenshot 1400 of a menu item 1402 of the toolbar 1202 titled “Overdrive”, which is an example name for the GUI platform. The menu item 1402 includes a dropdown menu which includes the following interactive elements: “build commands;” “find mouse position;” and “help.” FIG. 15 shows a screenshot 1500 of a menu item 1502 of the toolbar 1202 titled “Diagnoses.” The menu item 1502 includes the following functions: “AK”; “Healthcare Maintenance”; “Hypothyroid”; “Prostate Unspecified”; and “Type II Diabetes Controlled.” FIG. 16 shows a screenshot 1600 of a menu item 1602 of the toolbar 1202 titled “Lab Orders.” The menu item 1602 includes the following interactive elements: “Arthritis Panel”; “Diabetic Labs”; “PSA”; “Thyroid”; “Vit D”. FIG. 17 shows a screenshot 1700 of a menu item 1702 of the toolbar 1202 titled “Messaging.” The menu item 1702 includes the following interactive elements: “Nurse”; “Pool”. FIG. 18 shows a screenshot 1800 of a menu item 1802 of the toolbar 1202 titled “Progress Notes.” The menu item 1802 include the following interactive elements: “99203”; “99213” and “99214.”

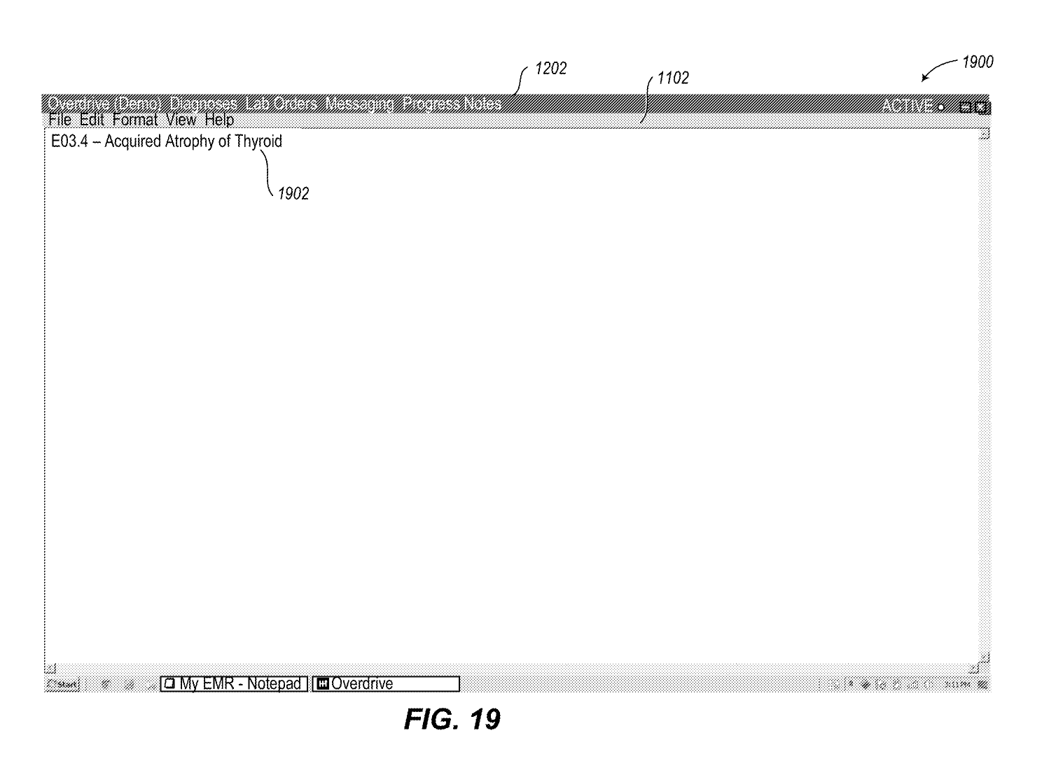

FIG. 19 shows a screenshot 1900 of text 1902 which results from selecting the interactive element (or command items) “Hypothyroid” from the menu item 1502 titled “Diagnoses” from the dropdown menu of the toolbar 1202. As shown, upon activation of the interactive element, the text is automatically inserted into the target application 1102.

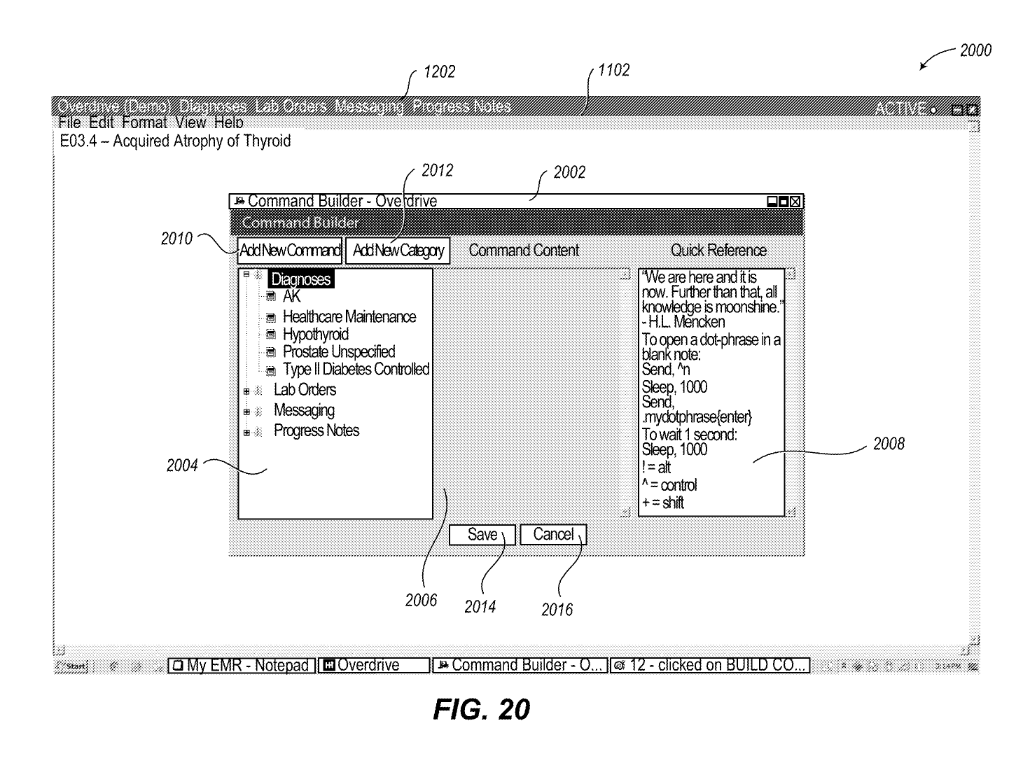

FIG. 20 shows a screenshot 2000 of an example command builder/editor UI 2002, such as the command builder UI 110 discussed above. The command builder 2002 includes a category/command window 2004, a command content window 2006, and a quick reference window 2008. The command builder 2002 may also include an “add new command” interactive element 2010, an “add new category” interactive element 2012, a “save” interactive element 2014, and a “cancel” interactive element 2016.

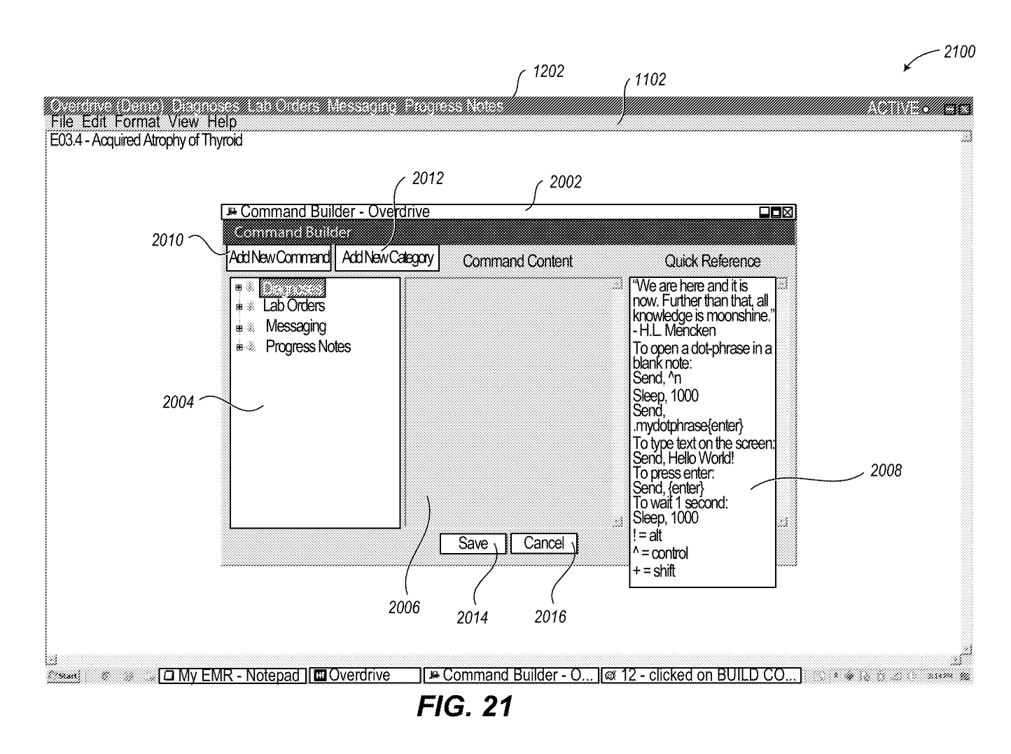

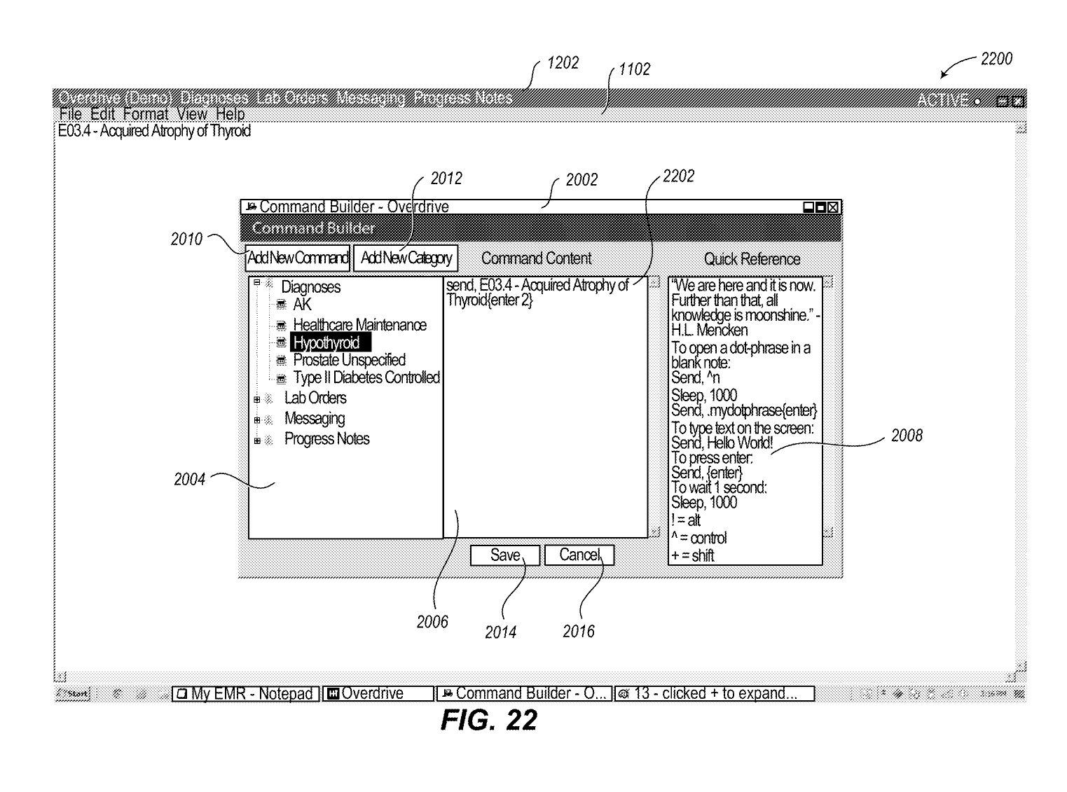

FIG. 21 shows a screenshot 2100 of the command builder 2002 in which the category/command window 2004 shows only categories and the commands within each category are hidden or “collapsed.” FIG. 22 shows a screenshot 2200 which shows content 2202 of the command “Hypothyroid” in the command content window 2006.

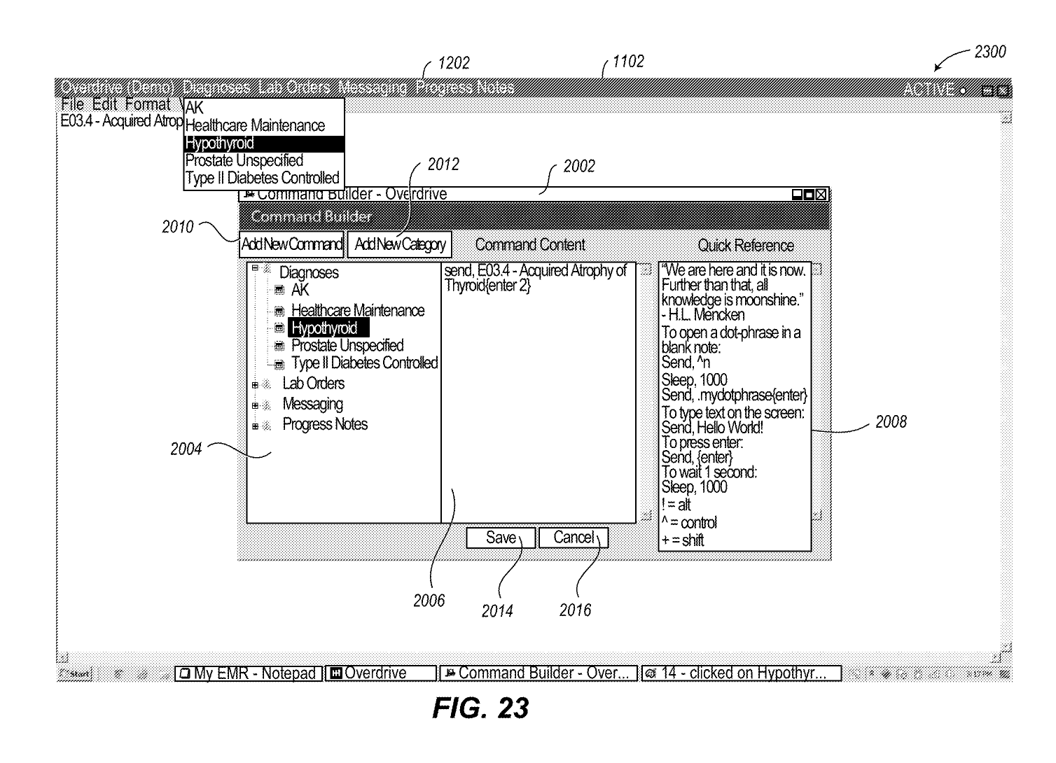

FIG. 23 shows a screenshot 2300 which shows the correspondence between the command builder 2002 and the items of the toolbar 1202. As shown, interactive element “Hypothyroid” 2302 corresponds to the command “Hypothyroid” shown in the category/command window 2004. Thus, in this example, the categories correspond to toolbar menu items and the commands within each category correspond to drop down interactive elements for the toolbar menu items.

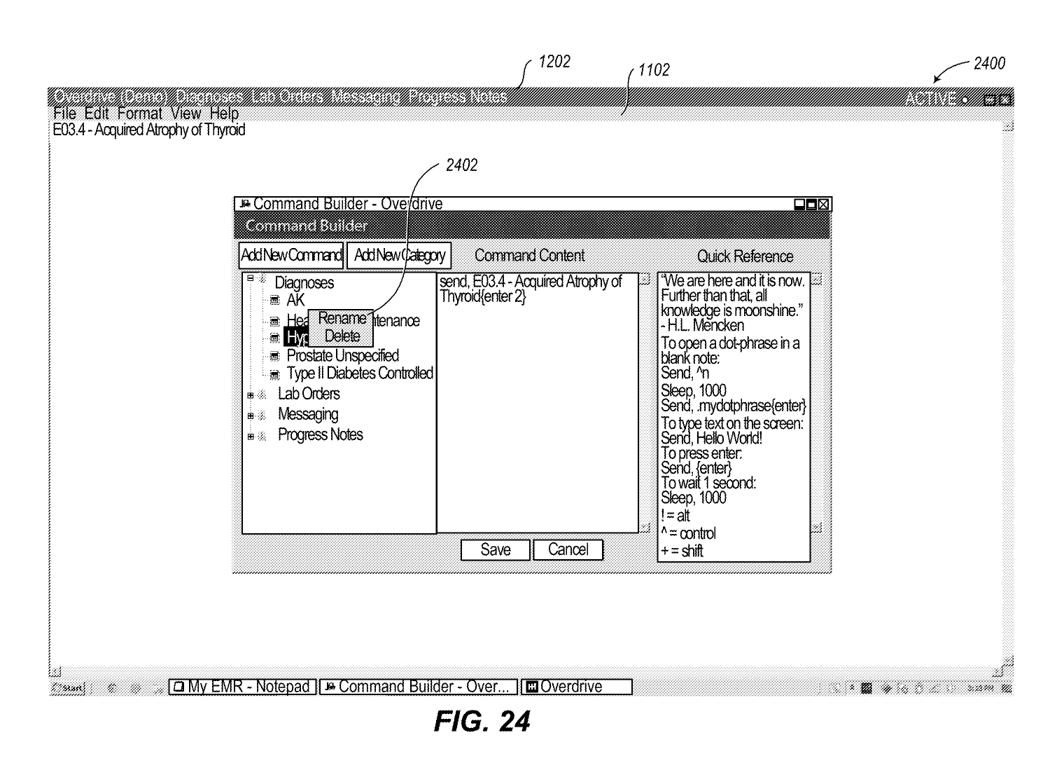

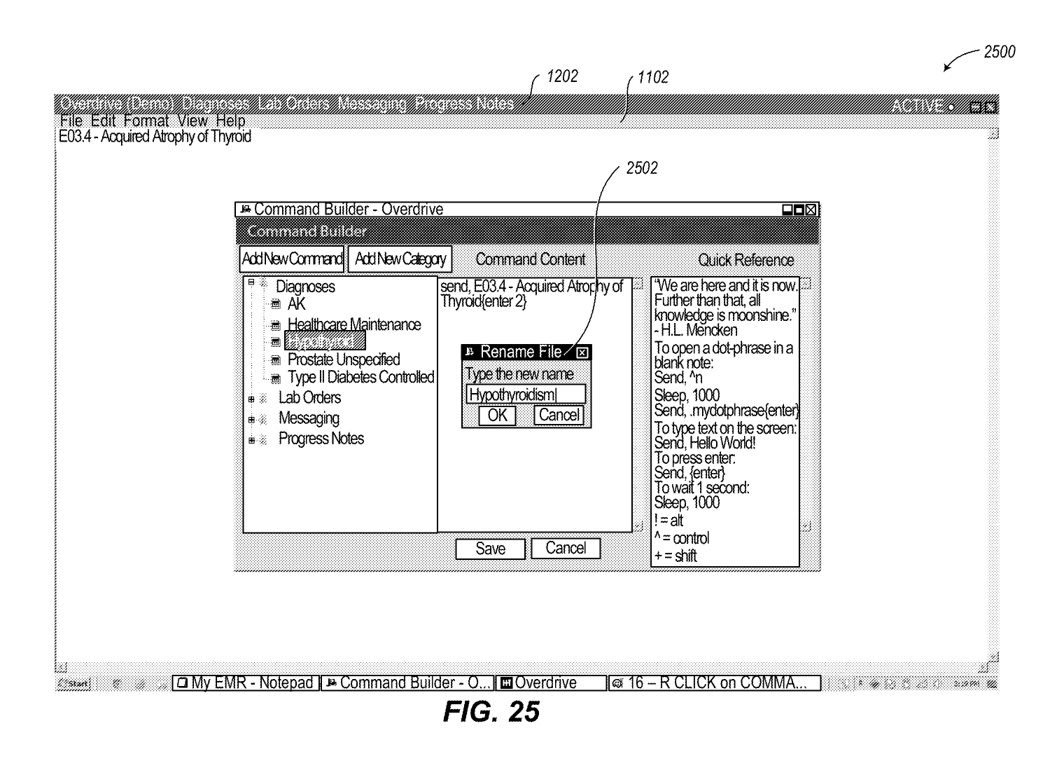

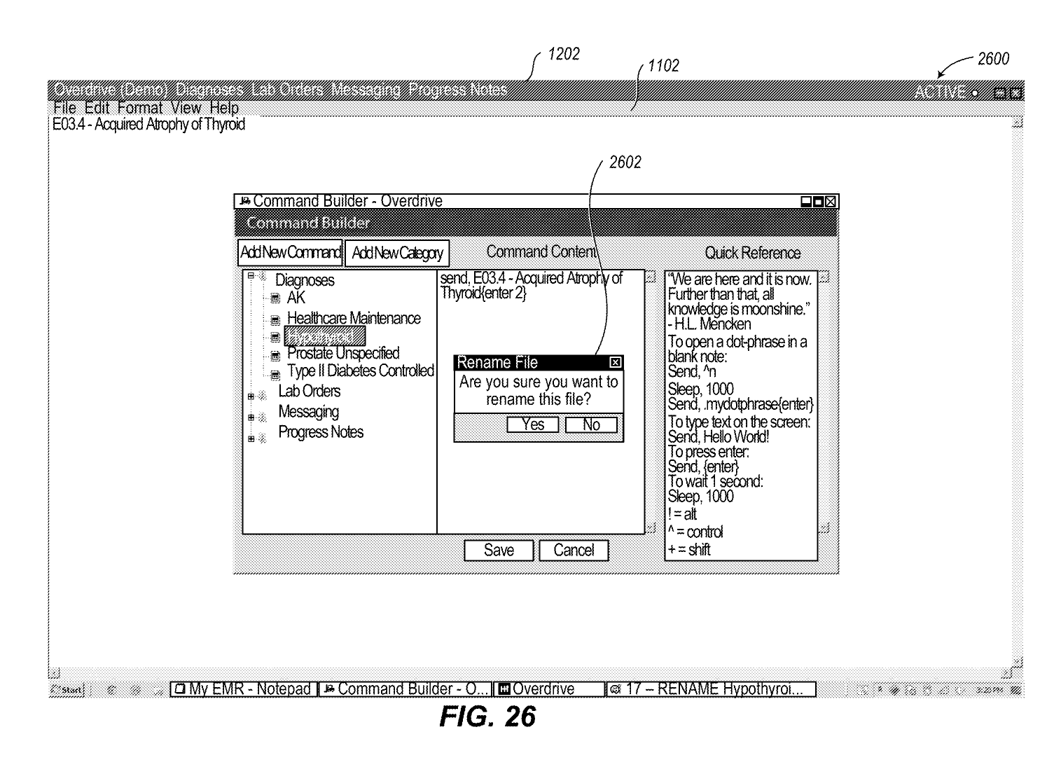

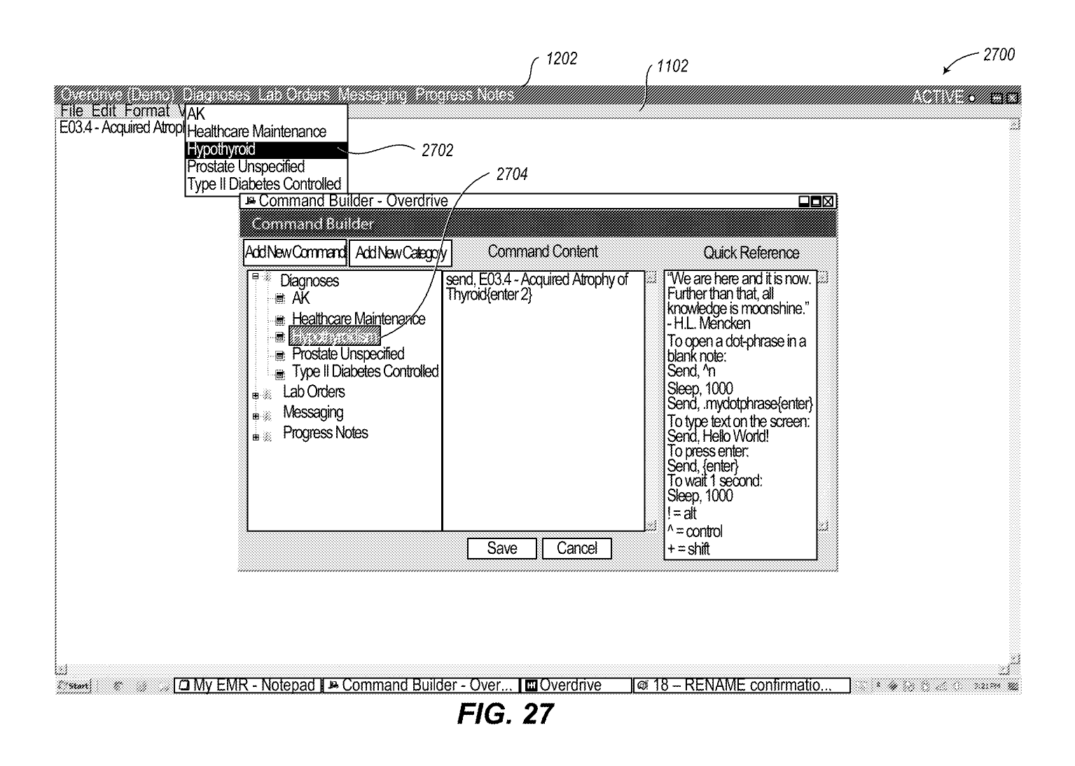

FIG. 24 shows a screenshot 2400 which shows a popup window or box 2402 which is displayed when a user right clicks on a command in the category/command window 2004. In this example, the popup box 2402 include interactive elements “Rename” and “Delete” which allow the user to rename or delete a command, respectively. FIG. 25 shows a screenshot 2500 which shows a popup box 2502 which includes a dialog box that allows the user to rename a command. The popup box 2502 may be display upon activation of the “Rename” interactive element of the popup box 2402 shown in FIG. 24. FIG. 26 shows a screenshot 2600 which shows a confirmation popup box 2602 which asks the user to confirm that the command is to be renamed. FIG. 27 shows a screenshot 2700 which shows that the command has been renamed both in the toolbar dropdown menu 2702 and the category/command window 2004.

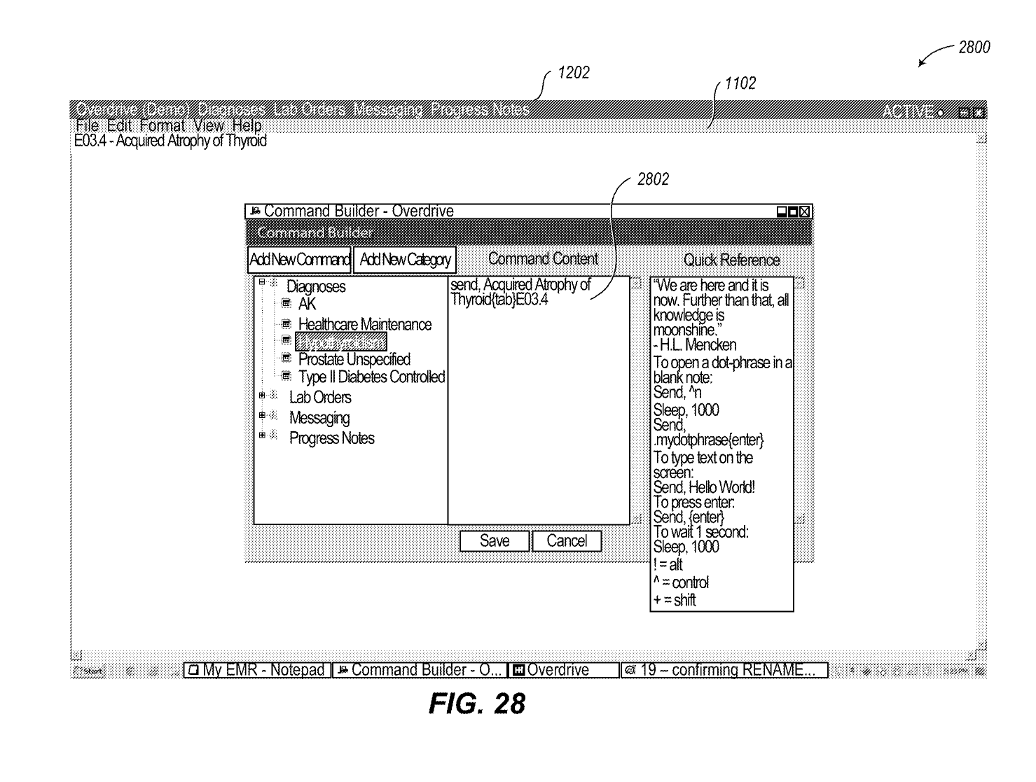

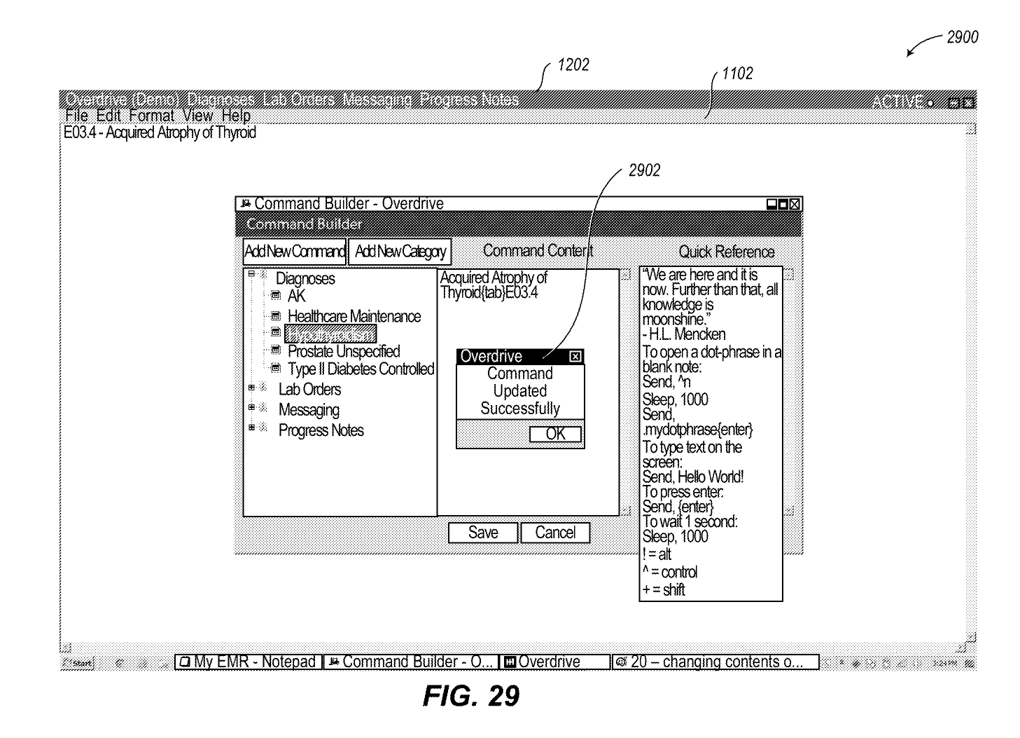

FIG. 28 shows a screenshot 2800 of the command builder 2002 which shows user changes 2802 to the command “Hypothyroidism” made in the command content window 2006. FIG. 29 shows a screenshot 2900 which shows a confirmation dialog box 2902 which confirms that the command “Hypothyroidism” was updated successfully. As an example, the dialog box 2902 may be displayed subsequent to the user activating the “save” interactive element 2014.

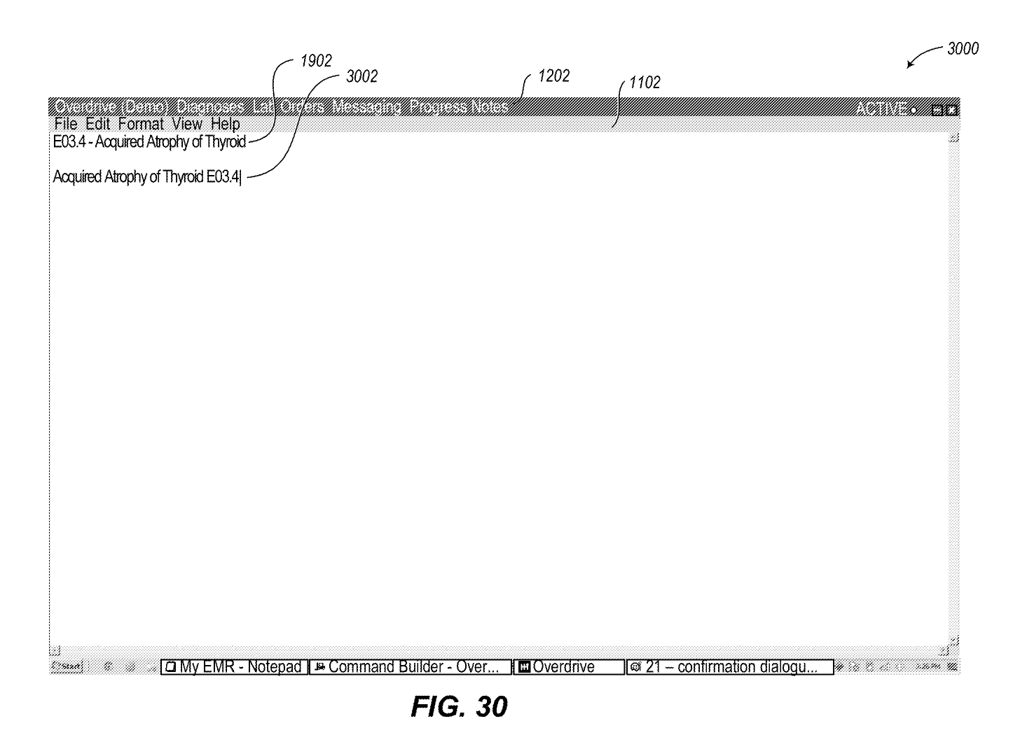

FIG. 30 shows a screenshot 3000 of the target application 1102 after the updated “Hypothyroidism” command has been executed. As shown, text 3002 reflecting the user changes 2802 (FIG. 28) appears in the target application upon execution of the updated “Hypothyroidism” command.

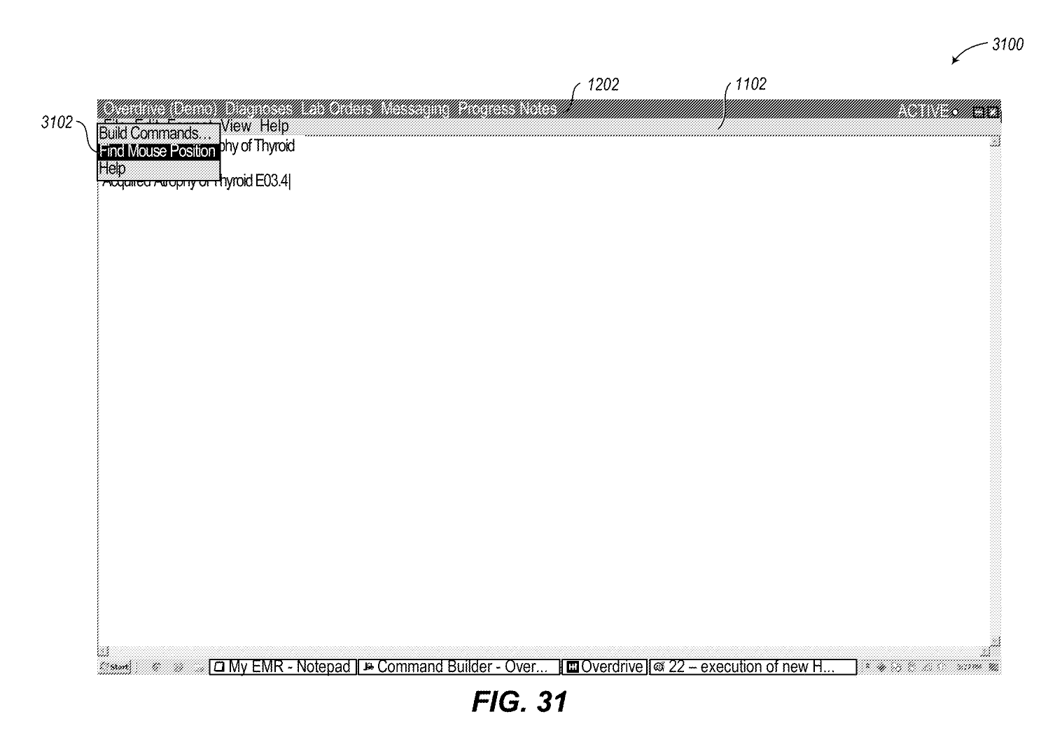

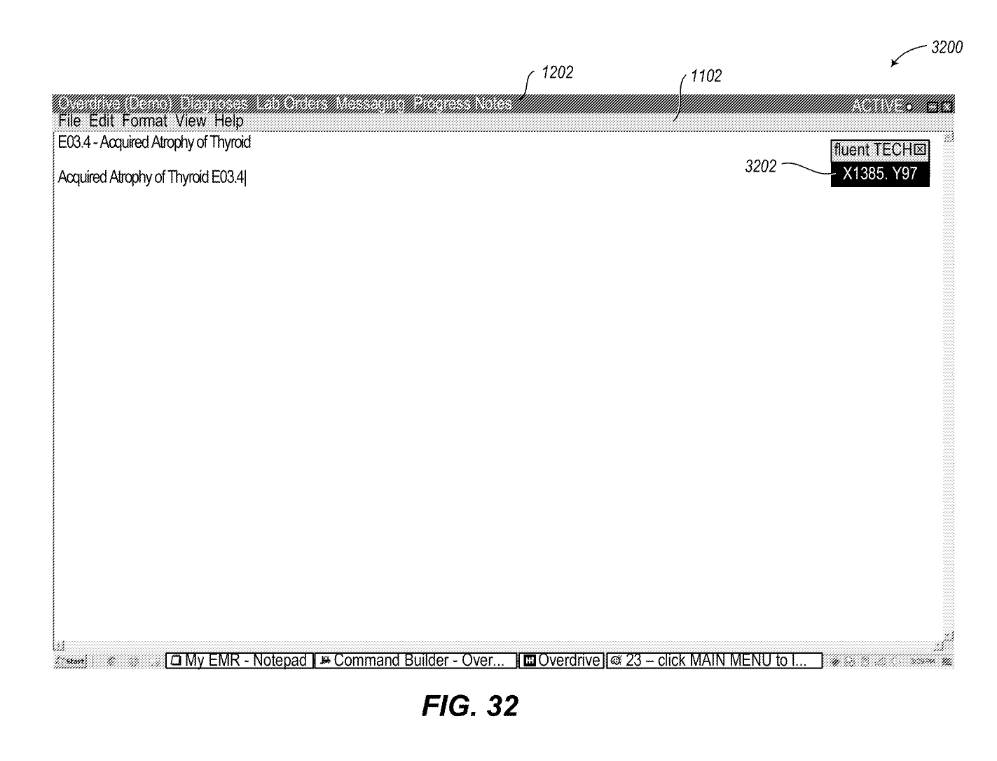

FIG. 31 shows a screenshot 3100 which shows a “find mouse position” interactive element 3102 of the toolbar 1202. FIG. 32 shows a screenshot 3200 which shows a find mouse position box 3202 which displays the X, Y coordinates of the user's mouse in real-time so that the user may utilize such information when building commands via the command builder UI 2002.

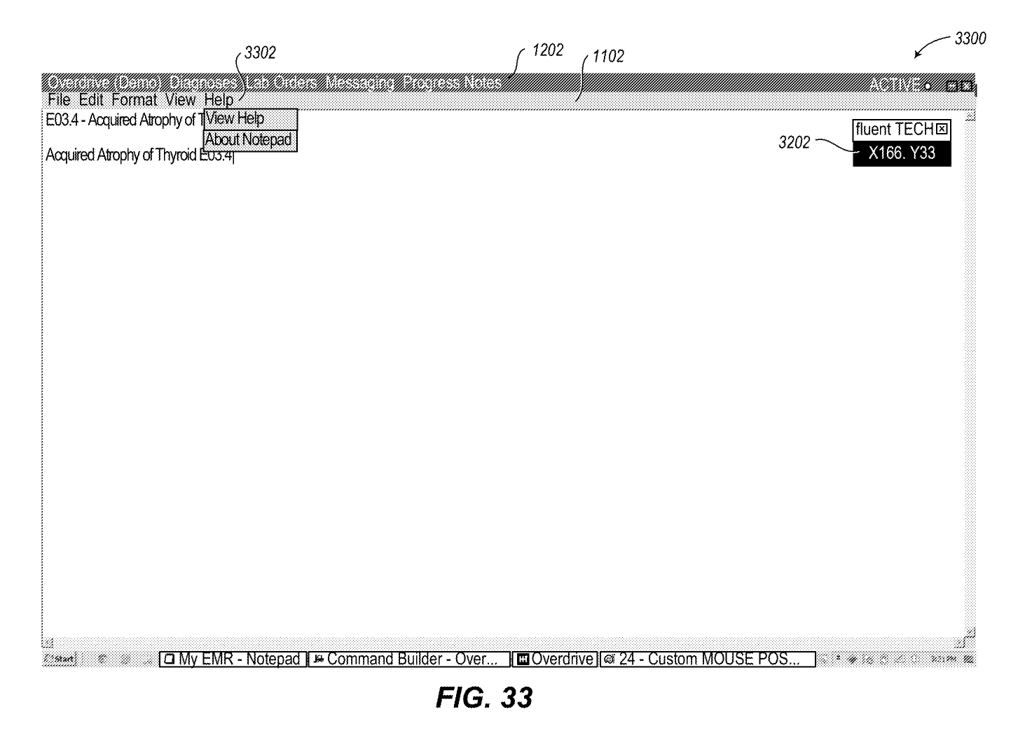

FIG. 33 shows a screenshot 3300 which shows the find mouse position box 3202 when a user's mouse is located on a “Help” menu item 3302 of the target application. As shown, the find mouse position box 3202 indicated the X coordinate of the mouse is at 166 and the Y coordinate of the mouse is at 33. Thus, the user may utilize such coordinates in the command builder 2002 to specify X, Y coordinates to “click” to select the “Help” menu item 3302.

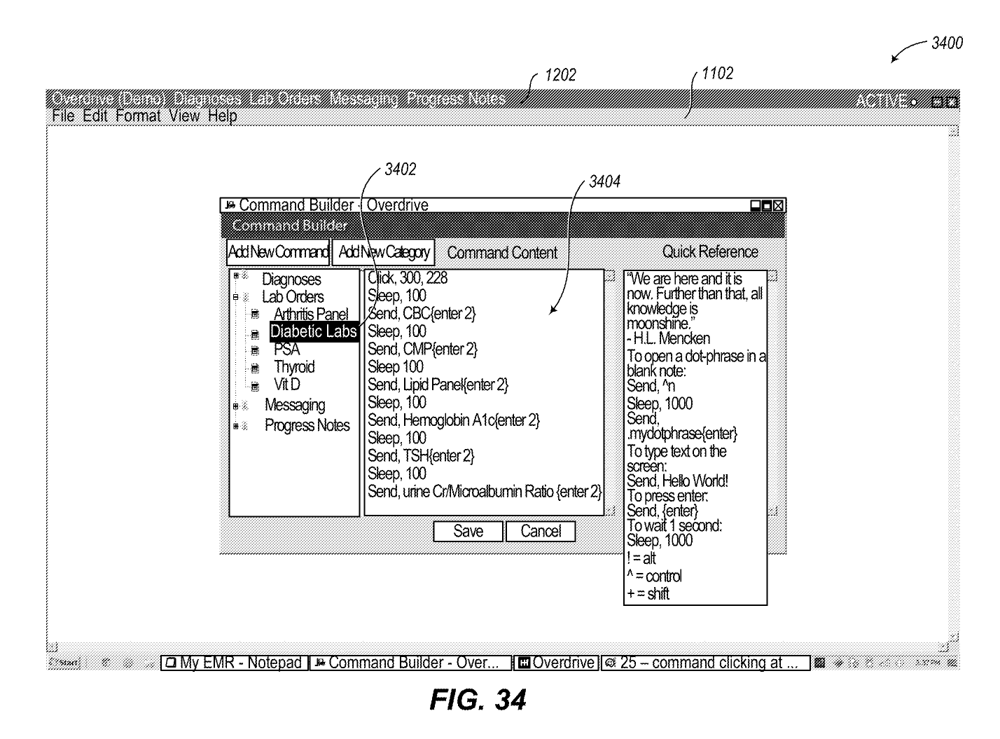

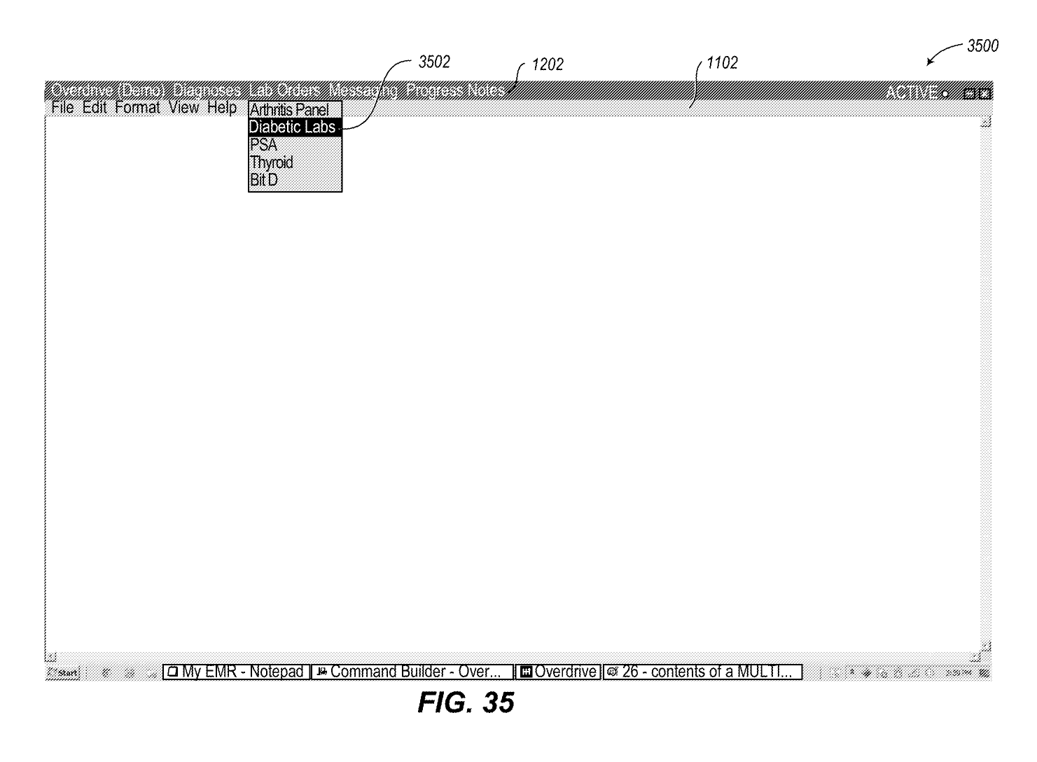

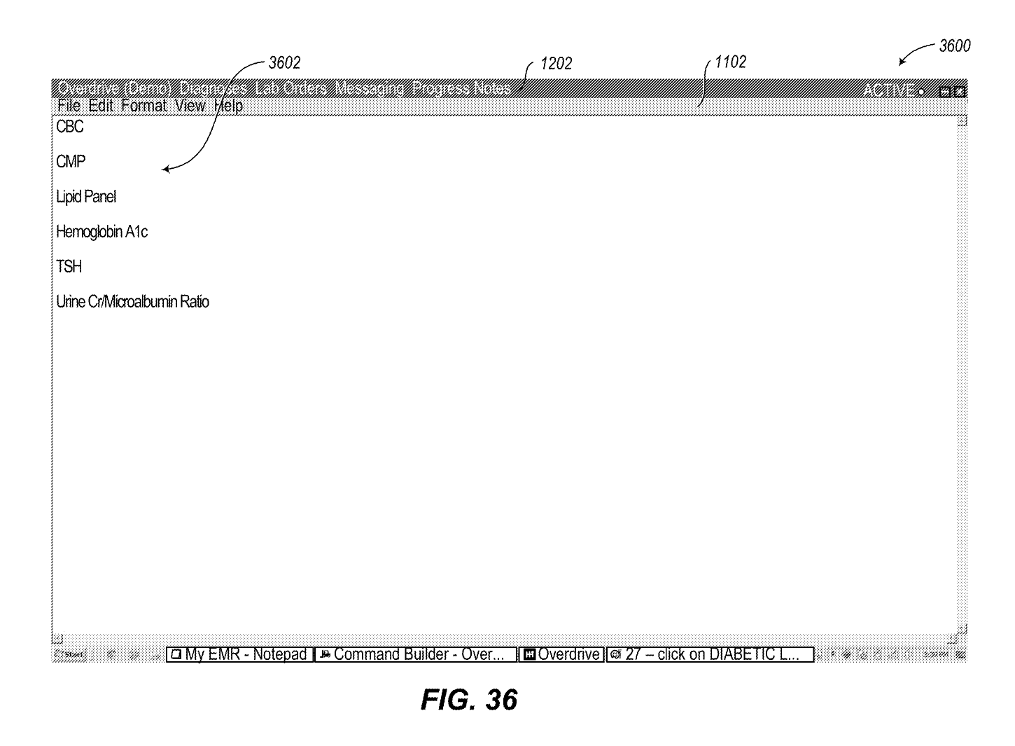

FIG. 34 shows a screenshot 3400 which shows a “Diabetic Labs” command 3402 highlighted in the category/command window 2004 and contents 3404 for the Diabetic Labs command in the command content window 2006. FIG. 35 shows a screenshot 3500 which shows a “Diabetic Labs” interactive element 3502 under the menu item titled “Lab Orders” in the toolbar 1202 which, upon activation, causes the Diabetic Labs command 3402 (Figure 3400) to execute. FIG. 36 shows a screenshot 3600 of the target application 1102 after text 3602 has been inserted into the target application as a result of execution of the Diabetic Labs command 3402.

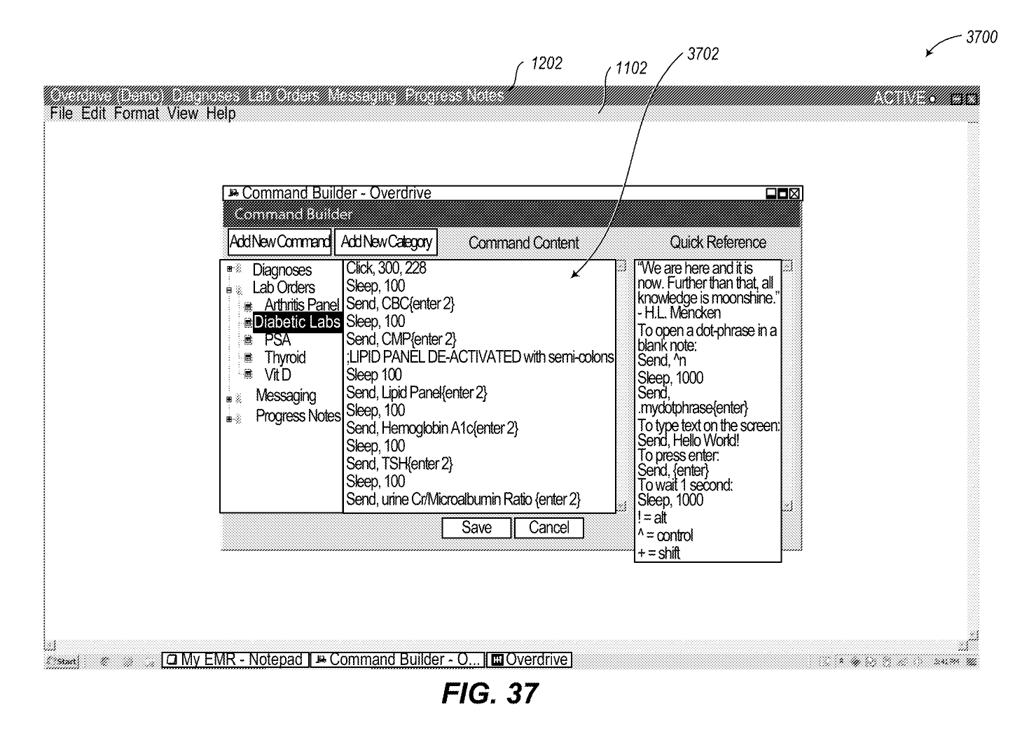

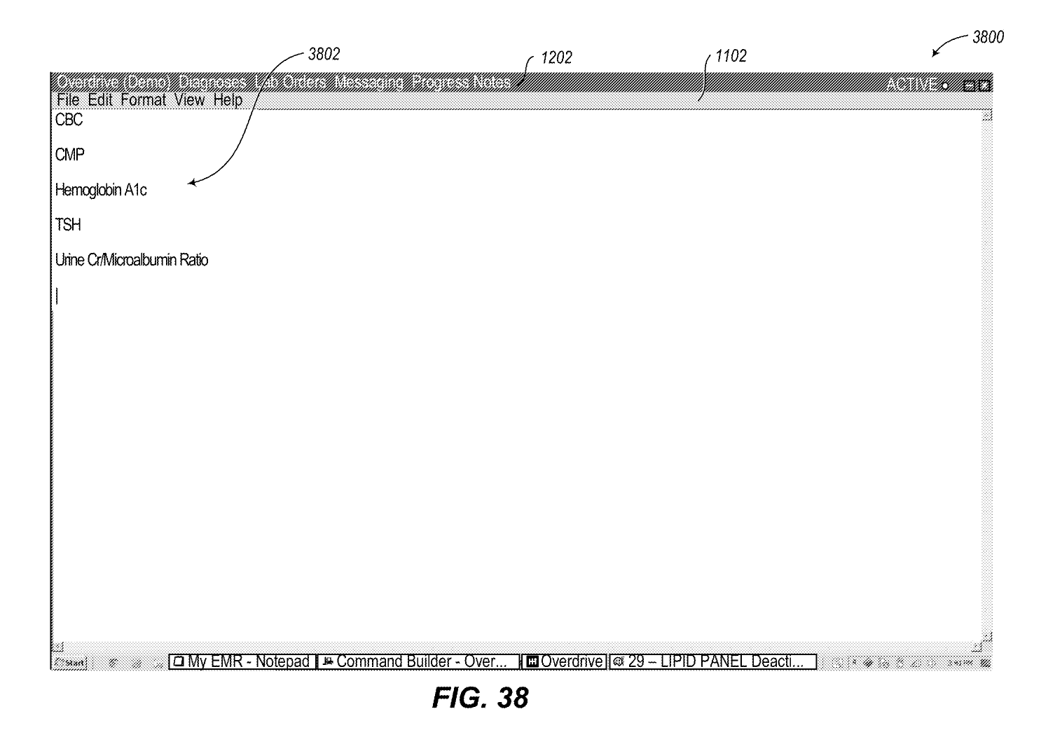

FIG. 37 shows a screenshot 3700 of the command builder 2002 which shows an edit 3702 to the Diabetic Labs command 3402 in the command content window 2006. FIG. 38 shows a screenshot 3800 of the target application 1102 after text 3802 has been inserted into the target application as a result of executing the edited or updated Diabetic Labs command 3402.

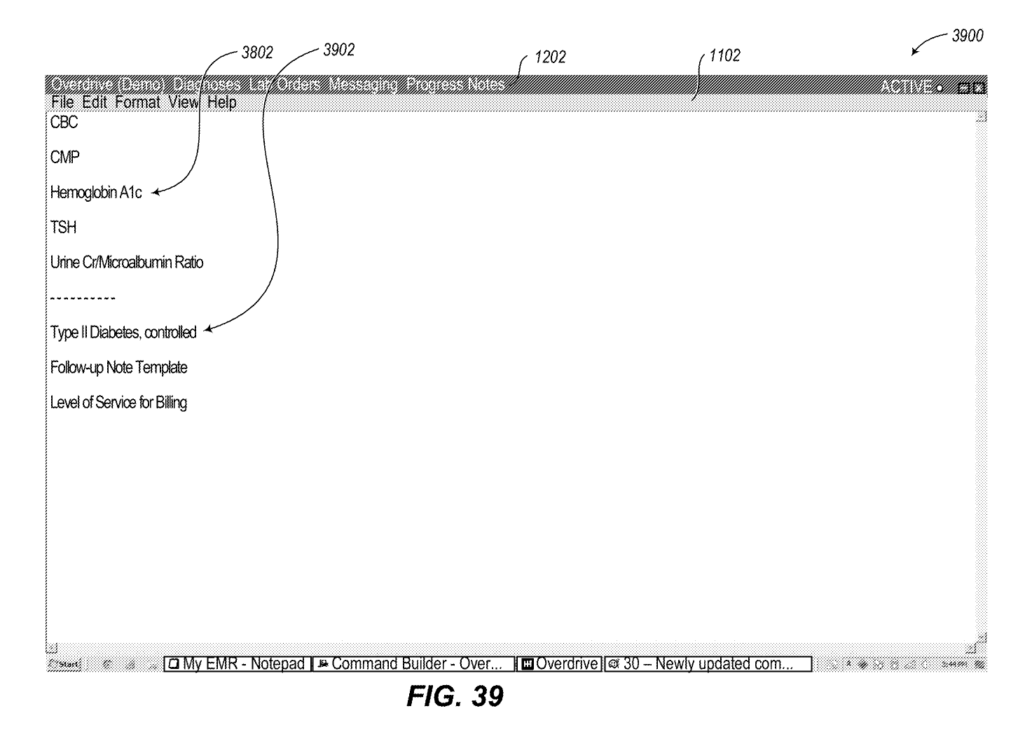

FIG. 39 shows a screenshot 3900 of the target application 1102 after text 3902 has been inserted into the target application as a result of executing another command.

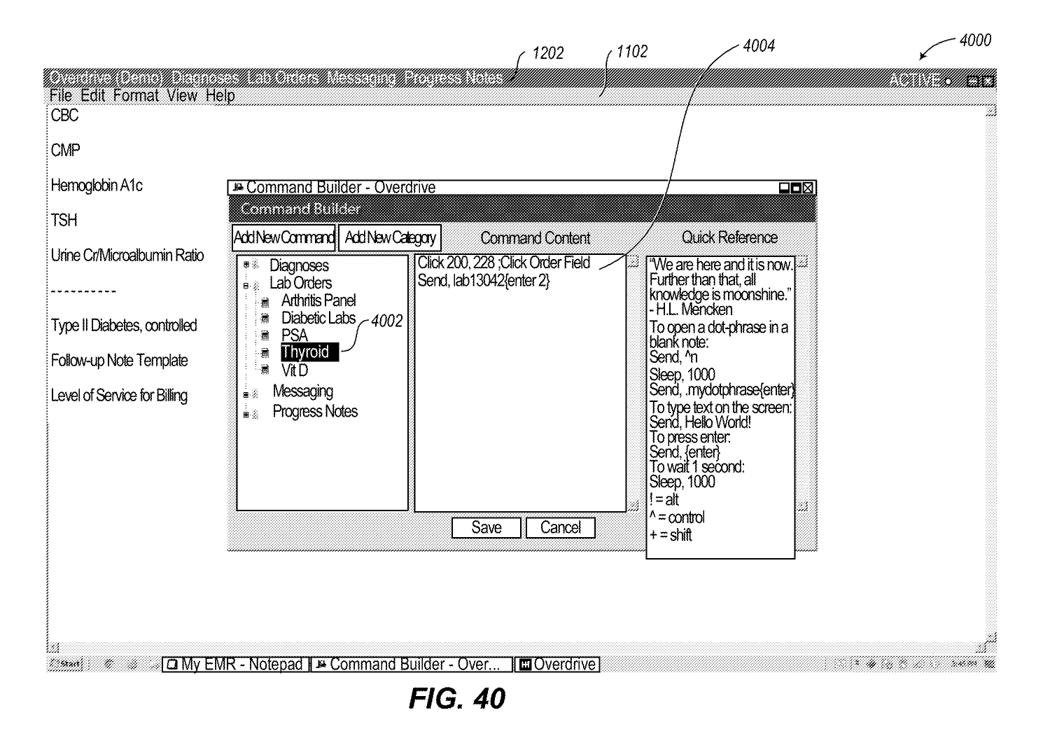

FIG. 40 shows a screenshot 4000 of the command builder 2002 which shows a Thyroid command 4002 and the contents 4004 of the Thyroid command in the command content window 2006.

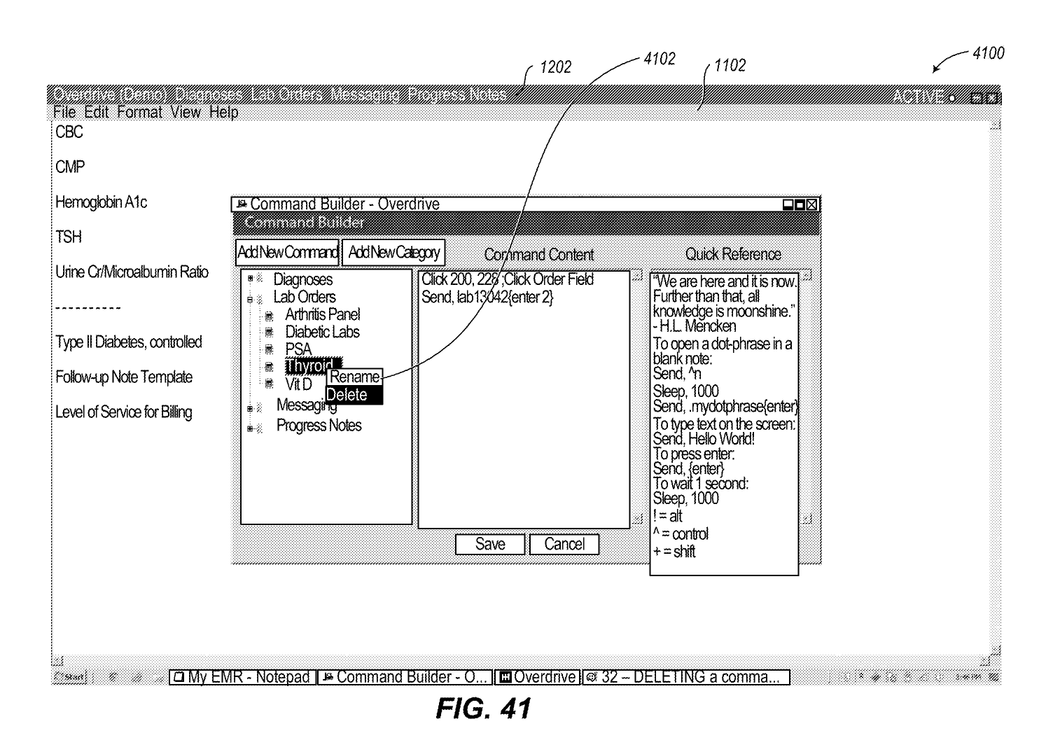

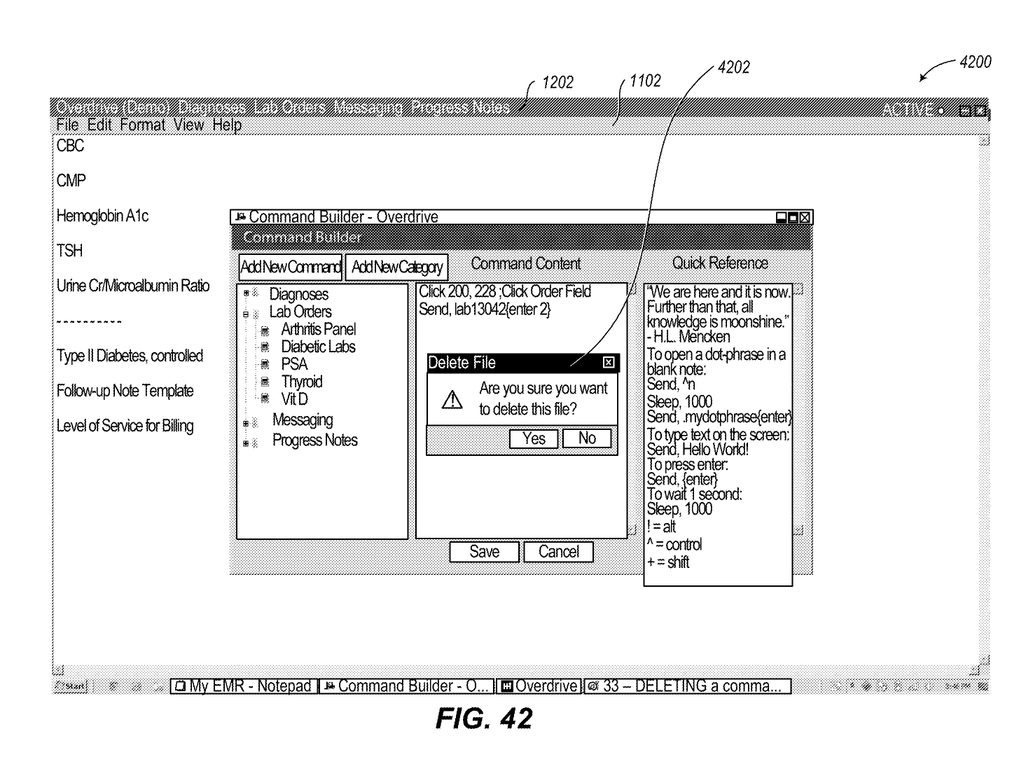

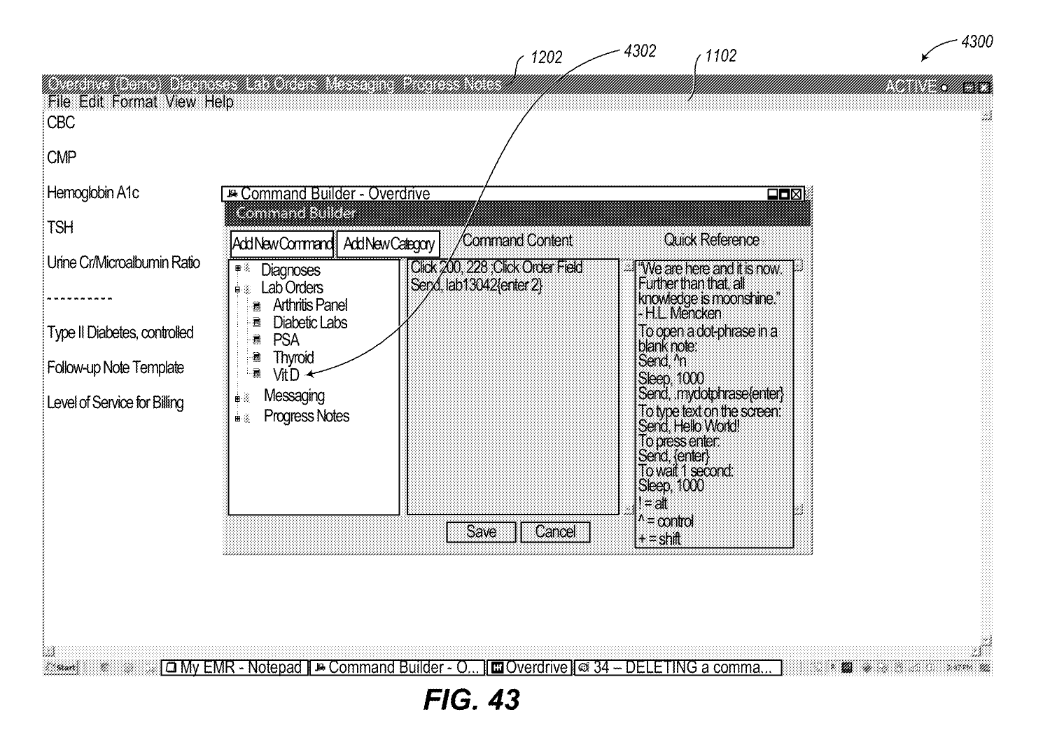

FIG. 41 shows a screenshot 4100 which shows a popup window or box 4102 which is displayed when a user right clicks on a command. In this example, the popup box 4102 include interactive elements “Rename” and “Delete” which allow the user to rename or delete a command, respectively. FIG. 42 shows a screenshot 4200 which shows a popup box 4202 which confirms that a user wants to delete a command. The popup box 4202 may be display upon activation of the “Delete” interactive element of the popup box 4102 shown in FIG. 41. FIG. 43 shows a screenshot 4300 which shows (as indicated by arrow 4302) that the Thyroid command 4002 no longer appears in the category/command window 2004 after the user has confirmed deletion of the command via the popup box 4202 (FIG. 42).

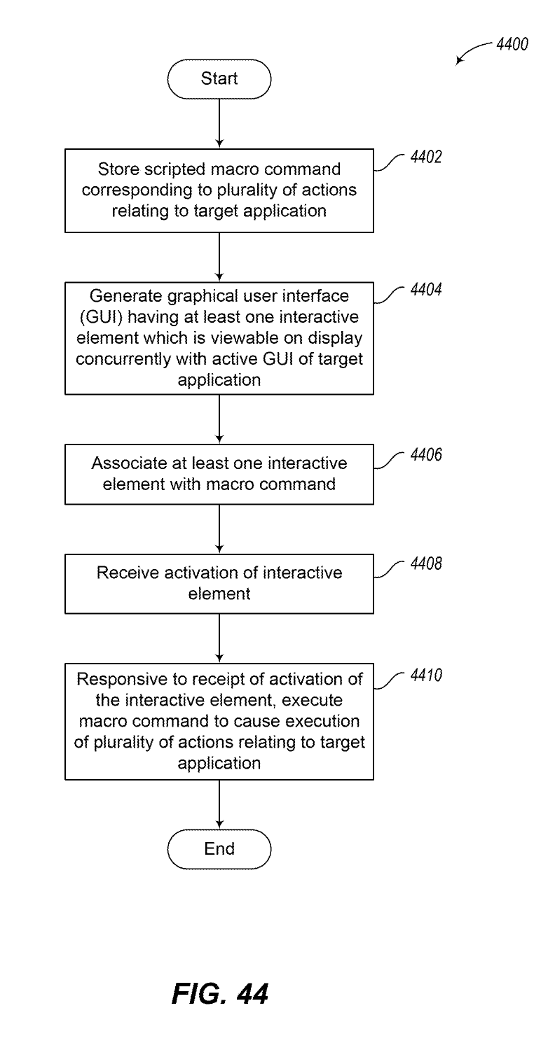

FIG. 44 is a flow diagram of a method 4400 of operation for a processor-based system to provide a simplified interface for a target application which executes on the processor-based system. The method 4400 begins at 4402 where at least one processor of the processor-based system stores a scripted macro command corresponding to a plurality of actions (e.g., 2 actions, 20 actions, 50 actions) relating to the target application on at least one nontransitory processor-readable storage medium communicatively coupled to the processor-based system. The macro command may include at least one of a keyboard command, a mouse command, a sub-macro command, a delay period, an application programming interface (API) command, or an operating system command, for example.

At 4404, the at least one processor may generate a GUI having at least one interactive element (e.g., button, menu item). Further, in some implementations, the GUI may be viewable on a display of the processor-based system concurrently with an active GUI of the target application (see FIG. 12). At 4406, the at least one processor may logically associate the at least one interactive element with the macro command.

At 4408, the at least one processor may receive an activation of the interactive element. For example, a user may click on the interactive element using a mouse or keyboard operatively coupled to the processor-based system. At 4408, responsive to receipt of the activation of the at least one interactive element, the at least one processor may execute the macro command to cause execution of the plurality of actions relating to the target application. As noted above, such plurality of actions may include one or more of a keyboard command, a mouse command, a sub-macro command, a delay period, an application programming interface (API) command, or an operating system command, for example.

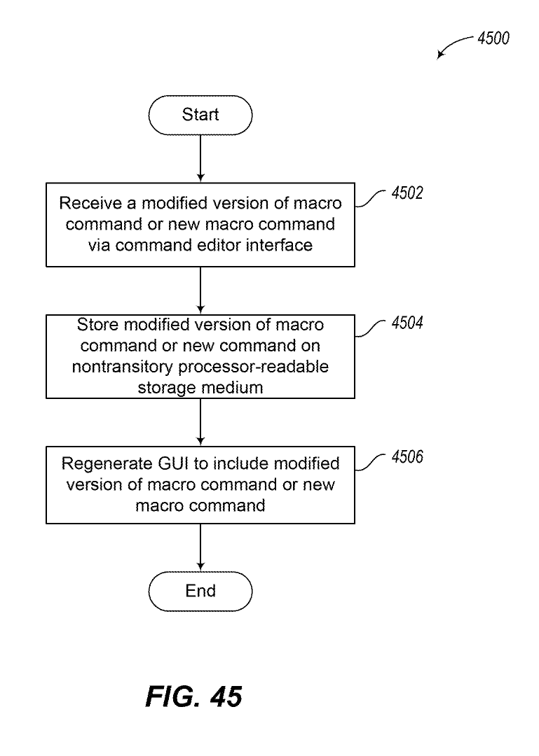

FIG. 45 is a flow diagram of a method 4500 of operation for a processor-based system to dynamically update a toolbar of a simplified interface of a GUI platform, such as the GUI platforms discussed above. At 4502, at least one processor of the processor-based system may receive a modified version of the macro command or a new command via a command editor interface. As discussed above, a user may modify a macro command or create a new macro command using the command content window 2006 (see FIG. 20). At 4504, the at least one processor may store the modified version of the macro command or the new command on at least one nontransitory processor-readable storage medium communicatively coupled to the at least one processor of the processor-based system. At 4506, the at least one processor may regenerate the GUI to include the modified version of the macro command or the new command. Thus, after the user has saved the modified or new command, the command is immediately available for use.

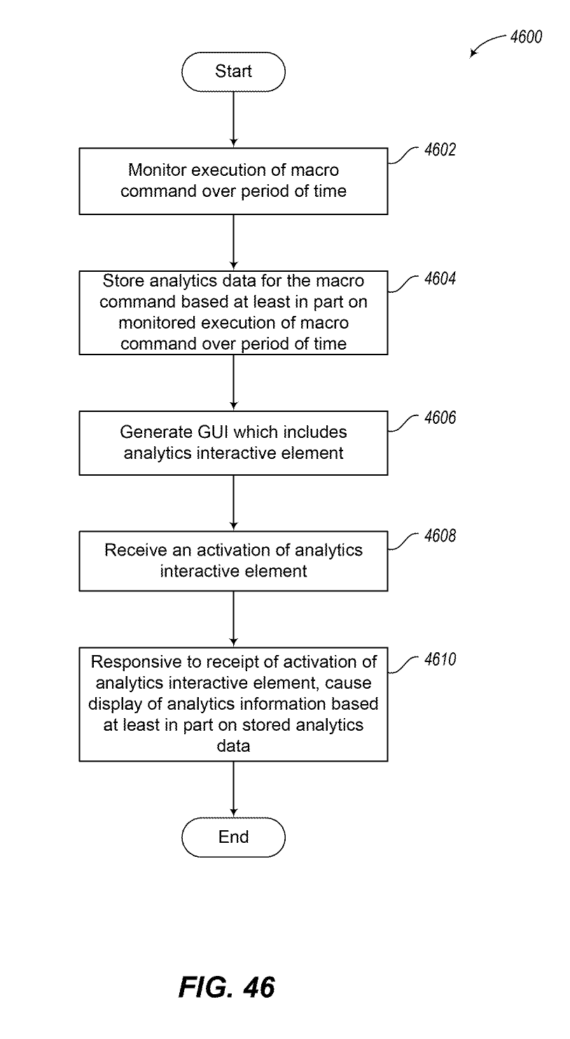

FIG. 46 is a flow diagram of a method 4600 of operation for a processor-based system to perform analytics related to the simplified interface of a GUI platform, such as the GUI platforms discussed above. At 4602, the at least one processor may monitor execution of the macro command over a period of time (e.g., hours, days, months, years). At 4604, the at least one processor may store analytics data for the macro command on at least one nontransitory processor-readable storage medium communicatively coupled to the at least one processor based at least in part on the monitoring of the execution of the macro command over the period of time.

At 4606, the at least one processor may generate a GUI which includes an analytics interactive element (e.g., button, menu item). At 4608, the at least one processor may receive an activation of the analytics interactive element. As an example, a user may click on an analytics menu item provided in a drop down menu of a toolbar, such as the toolbar 108 discussed above. At 4610, responsive to receipt of the activation of the analytics interactive element, the at least one processor may cause a display of analytics information on the display of the processor-based system. In at least some implementations, the analytics information may be based at least in part on the stored analytics data. As an example, the at least one processor may cause a display of at least one of a chart, a table, or a graph. In some implementations, the analytics data may include, for example, at least one of a number of executions of the macro command during the period of time, the number of actions which were automated, or a cumulative amount of time saved by executing the macro command during the period of time relative to executing the actions manually.

The at least one processor may include a running, resettable log of the time saved by utilizing the GUI platform. The macro commands in the log may be sorted by various criteria, such as most frequently used, most recently used, time saved, etc. In some instances, one or more triggers or thresholds may be used to identify when recent use of a macro command deviates from historical norms. In some instances, such information may be utilized to detect various trends (e.g., epidemic). In some implementations, the at least one processor of the GUI platform may screen scrape or scrub information from a target application to correlate macro executions with the target application.

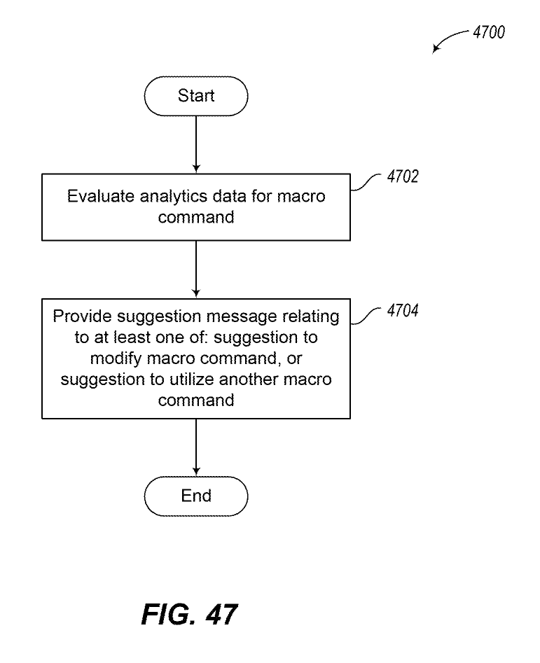

FIG. 47 is a flow diagram of a method 4700 of operation for a processor-based system to provide analytics-based suggestions to a user regarding the simplified interface. At 4702, at least one processor of the processor-based system may analyze or evaluate the analytics data for the macro command. At 4704, responsive to the evaluation of the analytics data for the macro command, the at least one processor may provide a suggestion message viewable on the display of the processor-based system. In at least some implementations, the suggestion message may relate to at least one of: a suggestion to modify the macro command or a suggestion to utilize another macro command. For example, the at least one processor may determine that a user may benefit from using a modified version of a macro command or a new macro command based on the interactions of the user with the target application. Such determination may be generated based on monitoring the actions of the user and/or monitoring the actions of a plurality of users (e.g., users that perform similar tasks).

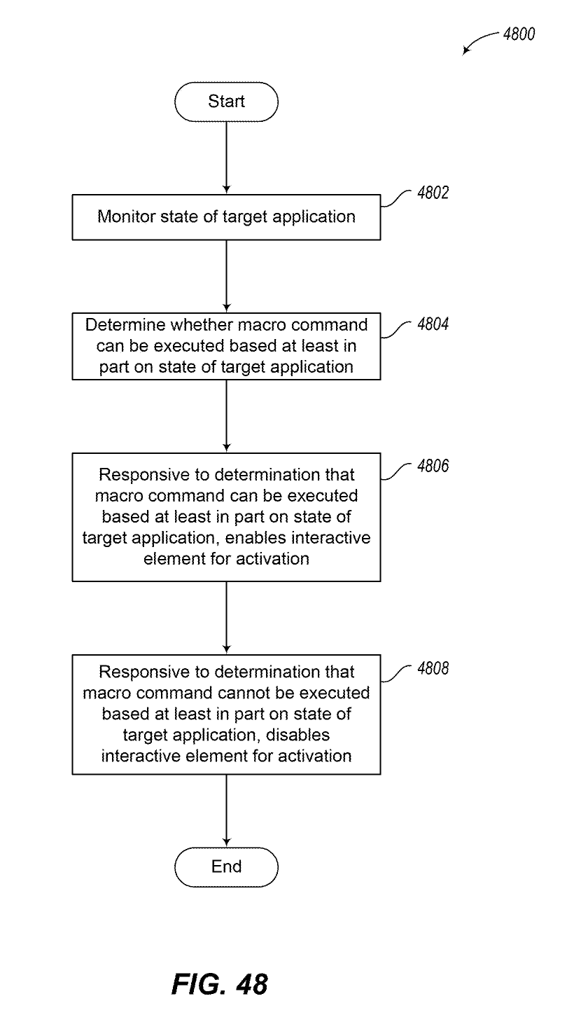

FIG. 48 is a flow diagram of a method 4800 of operation for a processor-based system to dynamically alter available macro commands which are available through the simplified interface based on a state of the target application. At 4802, at least one processor of a processor-based system may monitor a state of the target application. At 4804, the at least one processor may determine whether the macro command can be executed based at least in part on the state of the target application.

At 4806, responsive to a determination that the macro command can be executed based at least in part on the state of the target application, the at least one processor may enable the at least one interactive element for activation. At 4808, responsive to a determination that the macro command cannot be executed based at least in part on the state of the target application, the at least one processor may disable the at least one interactive element for activation. As an example, to disable an interactive element for activation, the at least one processor may cause the interactive element to be displayed with a light shade of gray (or a relatively lighter color), to indicate that the interactive element is currently disabled, and cannot be operated nor selected by the user. As another example, the at least one processor may cause the interactive element to not be shown when the interactive element is currently disabled. In some instances, the at least one processor may make macro commands adaptable to different starting points in the target application.

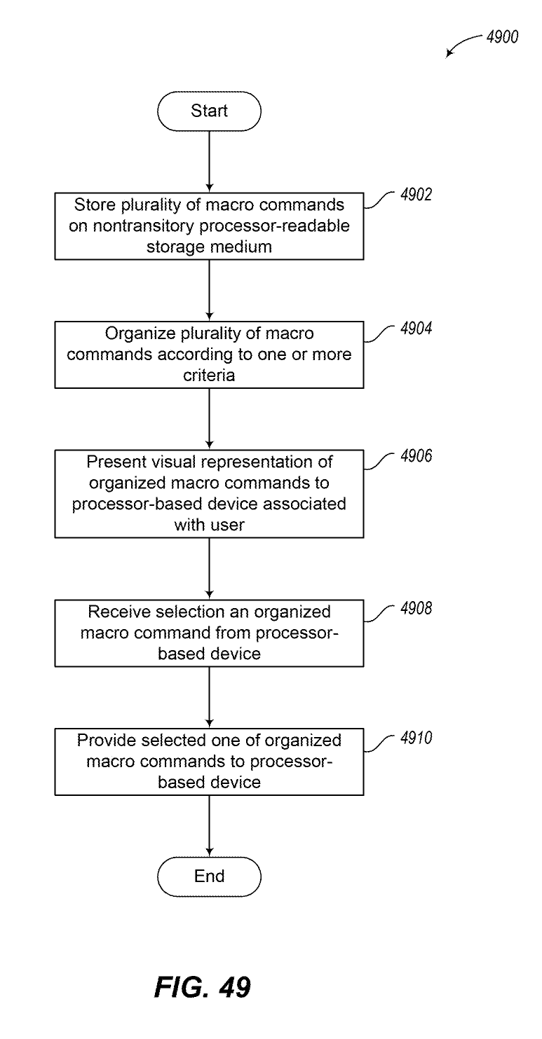

FIG. 49 is a flow diagram of a method 4900 of operation for a processor-based system to share a plurality of macro commands with a plurality of remotely located users. At 4902, the at least one processor may store a plurality of macro commands on at least one nontransitory processor-readable storage medium accessible by a plurality of processor-based devices associated with a plurality respective users via at least one data communications network (e.g., Internet). At 4904, the at least one processor may organize the plurality of macro commands according to one or more criteria.

For example, the at least one processor may organize the plurality of macro commands alphabetically, by rank, by rating, etc. In some implementations, the at least one processor may rank the plurality of macro commands based at least in part on: a detected frequency of use of each of the macro commands, or a user rating of each of the macro commands, for example. In some implementations, the at least one processor may organize the plurality of macro commands based at least in part on a nested hierarchy of categories and sub-categories. In some implementations, the at least one processor may organize the plurality of macro commands based at least in part on: a user type, an organizational unit, an operating system type, or a target application type. The system may allow for macros to be searched using various search criteria, including keywords, subject, title, field, target application, OS, ranking, rating, etc.

At 4906, the at least one processor may present a visual representation of at least a portion of the organized macro commands to a processor-based device associated with a user. The visual presentation may be based at least in part on the organizing of the plurality of macro commands, as discussed above. At 4908, the at least one processor may receive a selection of one of the organized macro commands from the processor-based device associated with the user. At 4910, the at least one processor may provide the selected one of the organized macro commands to the processor-based device associated with the user via the at least one data communications network. For example, the at least one processor may provide a link which allows the user to download the selected macro command to the user's local processor-based system.

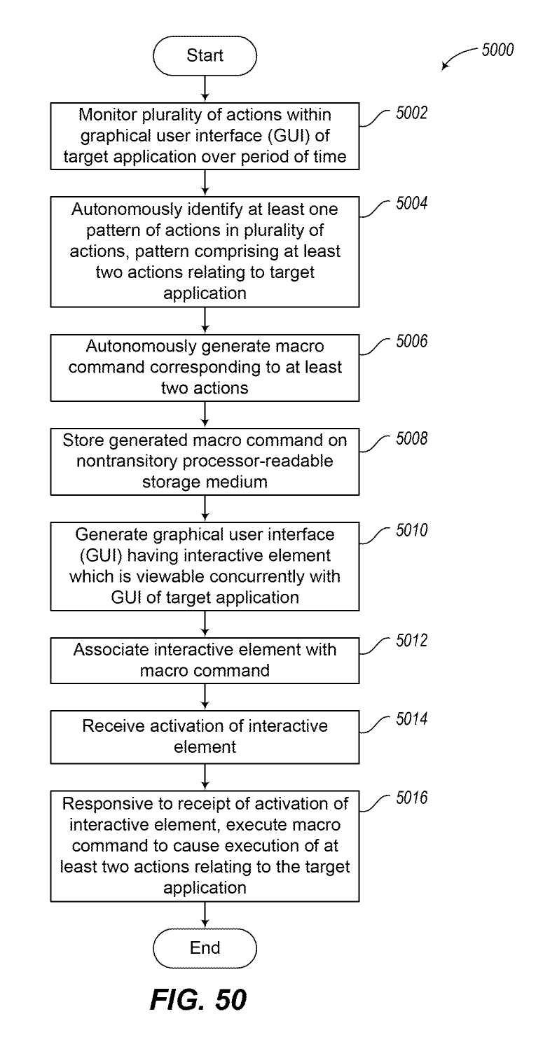

FIG. 50 is a flow diagram of a method 5000 of operation for a processor-based system to autonomously generate macro commands for the simplified interface. At 5002, at least one processor of the processor-based system may monitor a plurality of actions within a GUI of the target application over a period of time. The at least one processor may monitor actions executed by a single user and/or actions executed by a plurality of users (e.g., a group of users sharing one or more criteria). At 5004, the at least one processor may autonomously identify at least one pattern of actions in the plurality of actions. In some implementations, the at least one pattern may include at least two actions relating to the target application. At 5006, the at least one processor may autonomously generate a macro command corresponding to the at least two actions in the pattern of actions relating to the target application. For example, upon identifying that a user (or a group of users) repetitively perform the same plurality of actions, the at least one processor may autonomously generate a macro command which automates the plurality of actions. At 5008, the at least one processor stores the generated macro command on the at least one nontransitory processor-readable storage medium for subsequent use by one or more users.

In some implementations, the at least one processor may monitor at least one of: a keyboard command, a mouse command, a sub-macro command, a delay period, an application programming interface (API) command, or an operating system command, for example. In some implementations, the at least one processor may monitor execution of a sub-macro command relating to the target application. In some instances, the at least one processor may generate a macro command which includes one or more sub-macro commands and at least one additional action relating to the target application. For example, the at least one processor may determine that after executing a first macro command, a user often subsequently performs an additional one or more actions. The at least one processor may append the one or more actions to the first macro command to generate a new second macro command which includes the first macro command (as a sub-macro command) and the additional one or more actions. Similarly, the at least one processor may recognize that the user executes multiple macro commands in sequence. The at least one processor may generate a new macro command which combines the multiple macro commands into a single macro command which comprises multiple sub-macro commands.

At 5010, the at least one processor may generate a GUI having at least one interactive element. In some implementations, the GUI is viewable on a display of the processor-based system concurrently with the GUI of the target application, as discussed above. At 5012, the at least one processor associates the at least one interactive element with the macro command. At 5014, the at least one processor may receive an activation of the interactive element, for example, by a user clicking or otherwise selecting the interactive element. At 5016, responsive to receipt of the activation of the at least one interactive element, the at least one processor may execute the macro command to cause execution of the at least two actions relating to the target application.

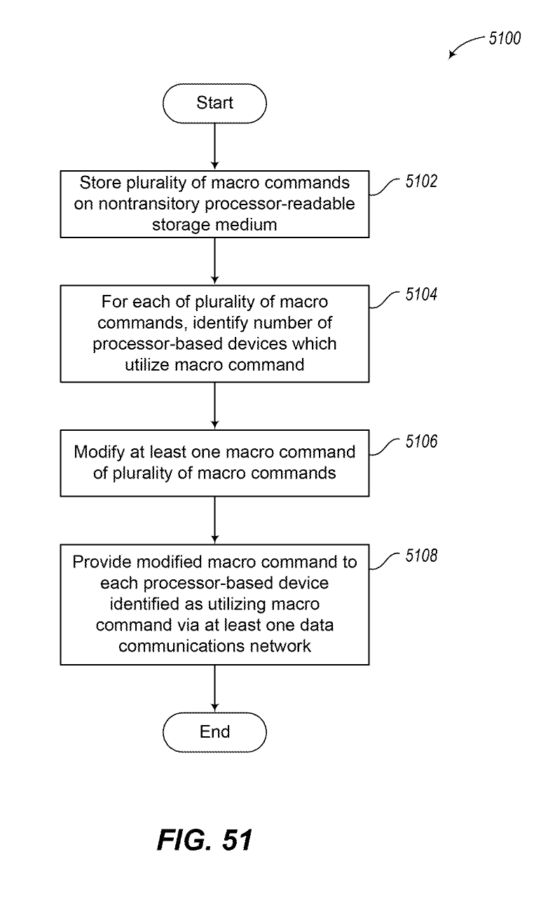

FIG. 51 is a flow diagram of a method 5100 of operation for a processor-based system to provide new or updated macro commands to a plurality of processor-based devices associated with a plurality of respective users. At 5102, at least one processor of the processor-based system may store a plurality of macro commands on at least one nontransitory processor-readable storage medium communicatively coupled with the at least one processor. The macro commands may be existing macro commands, modified macro commands, and/or newly created macro commands. At 5104, for each of the plurality of macro commands, the at least one processor may identify a number of processor-based devices which utilize the macro command. At 5106, the at least one processor may modify at least one macro command of the plurality of macro commands or generate a new macro command. At 5108, the at least one processor may provide the modified macro command or the new macro command to each of the number of the processor-based devices identified as a candidate to utilize the macro command via at least one data communications network. For example, in some implementations, the at least one processor may simultaneously provide (or “push”) the modified macro command to each of the number of processor-based devices via the at least one data communications network without receipt of a request for the modified macro command from at least one of the number of the processor-based devices. In such instances, a “super user” may push new or modified macro commands to a plurality of users simultaneously and/or sequentially, so that each of the plurality of users always has updated macro commands available for use. In some implementations, the at least one processor may provide access (e.g., via a link) to the modified macro command to each of the number of processor-based devices over the at least one data communications network.

In some implementations, a provider of the GUI platform may provide a website or other interface where users can login, which may provide access to personal commands, and allows access to the command builder to build and edit commands. Such may be built using AJAX, JavaScript, Ruby, Python, etc., for example. The website may also allow download and installation of the cross-platform toolbar (e.g., Java), which allows users to access and execute personal commands from any computer (Windows, Mac, Linux, etc). Of note, in some implementations toolbars may be machine or context specific, which means that if a user wants certain commands and organization in one context (like using a particular PC or group of PC's), then that is what is presented to the user.

In some implementations, cloud storage is used to store a database of all users' commands and data, protected with username and password for access. Users may not be able to see each other's commands, unless they specify to share specific ones. User's commands may also be automatically backed up and restored from the cloud database.

In some implementations, there is a built in “social sharing” component to the website, app, or interface. Users can share commands, workflows, and algorithms for efficiency with peers. There may be inter-user web-based messaging and a personal feed of information that the user is interested in. Feed contents may show commands, workflows, and algorithms that are chosen because they are from “friends” of the user, or because they are from users who are automating the same programs, or work in the same type of context (like a family physician on a specific EMR in the exam room). The system may also include a “would you like to see what other's like you are doing?” function. If a user selects this option, the user is shown commands, descriptions, how many times used, who is using, and estimated time saved of popular commands by users who are automating the same kinds of things they are.

Push application updates and push messages to the user may be controlled from the cloud based system. Messages to the user may be similar to a smartphone notification, and may include things like an update that the software they are automating has been or will be upgraded and that there will be work done to update commands or the functionality of the toolbar so that automation continues to work as expected.

The cloud may also store in a database a repository of template automation commands. These may be organized by popularity, what they do, and who might use them (application being automated, specialty of the user using the application). “Care Packages” are electronic “gifts” that are delivered to the user on an intermittent schedule. These are delivered using push technology and notifications similar to above described push messages. Such “gifts” may be context relevant to the user, and may include a time-saving strategy, a motivational quote, relevant professional information, or a notification of a new plug-in that may help the user by increasing functionality of the toolbar(s) or command builder, for example.

Analytics in the cloud may be performed by analyzing the user's commands and number of times executed, for example. Context may be used to estimate how much time each individual command saves each time it is executed. Multiplying the amount of time saved per command by the number of times executed will give the cumulative amount of time saved per command. Adding up all the totals for all commands provides an estimated total time saved. These analytics also help suggest to the user commands which may save them more time. Analytics can be displayed by the day, week, month, quarter, and year, for example. Custom display of the data may be provided with plug-ins. Analytics may also allow for anonymous evaluation of a user's commands to help understand the contents of the types of commands that are being used most, and what user's may find most valuable for automation.

As discussed above, the GUI toolbar may be built as an overlay across the top of the screen (see FIG. 12). Plug-ins allow different designs to be coded and chosen for the toolbar. Custom designs allow the best integration with the workflow of the application being automated. Options include “always-on-top” skin type toolbars that stay on top of part of the application. Skin type toolbars follow the application they are associated with (minimize with the app, move with the app, etc). Other options are toolbars that reserve part of the screen such as a rectangle similar to the windows taskbar. This kind of toolbar may be placed on the bottom, top, or either side of the screen. Floating toolbars are also an option.

The toolbar may have a name that is displayed from a variable. The name may be customizable by the user or the system. The name can be hidden if desired. The toolbar can also be labeled with an identifying graphic icon or logo. Clicking on the toolbar name may present the toolbar's “main menu,” with an option to build commands, find mouse position, change app settings, or get help, for example. In some implementations, there are dropdown menus on the toolbar. The menu headings may be created by looping through the directory of the user's commands, for example. The dropdown menu commands themselves may be created by looping through the files within the folders in the user's directory. In some implementations, the commands may be executed by a left click of the mouse on a menu item. Commands may also be executed by other triggers, such as when specific pixels appear on the screen.

When the dropdown commands are built, they may be coded to trigger execution of the instructions that the user made in command builder. This may be done by associating the dropdown menu item directly to the correlating command contents in the commands.dat file.

Updating the contents of a command in command builder or making a new command may autonomously refresh the toolbar with the newly configured command, and may display it in the way the user wants to see it. This means that the dropdown menus may be initially organized alphabetically, but can be sorted any way desired, including drag-and-drop manual sorting, by most frequently used, and other organizing techniques. This is also true for the individual commands within folders. Such individual commands may be organized however the user wants to display them. Again, this organization may happen in the command builder, which controls how the toolbar is populated.

As noted above, the command builder may include mouse clicks, pressing keys, typing text on the screen, waiting for a specified period of time, OS commands, etc. The default wait time between steps may be set to a predetermined time (e.g., 500 milliseconds), but can be adjusted by the user.

The different implementations of the dynamic GUI platform described herein provide several advantages over known solutions. For example, one or more of the illustrative implementations described herein allow organization of commands and on-the-fly toolbar generation and reconfiguration. Additionally, one or more of the implementations described herein allow network-based user sharing of command scripts, make it easy for an average user to create and share automation, and also to use automation in an intuitive and organized way. At least some implementations allow for controlling any application across multiple platforms, and give analytical feedback on time savings to the user. One or more implementations described herein may also improve the quality of data input to critical systems such as EMR applications, facilitate one-click workflows, provide understandable organization and layout, provide intuitive organization of complex functions, provide user-specific individualization, provide a social platform for user-based solutions, and provide significant financial and social impact. No known system or device can perform these functions, particularly in complex environments such as electronic medical record applications. Not all implementations described herein provide the same advantages or the same degree of advantage.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative implementation applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various implementations described above can be combined to provide further implementations. To the extent that they are not inconsistent with the specific teachings and definitions herein, all of the U.S. patents, U.S. patent application publications, U.S. patent applications, foreign patents, foreign patent applications and non-patent publications referred to in this specification, including U.S. Provisional Patent Application Ser. No. 62/151,929, filed Apr. 23, 2015, are incorporated herein by reference, in their entirety. Aspects of the implementations can be modified, if necessary, to employ systems, circuits and concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1.-46. (canceled)

47. A processor-based system to provide a simplified interface for a target application which executes on the processor-based system, the system comprising:
at least one nontransitory processor-readable storage medium that stores at least one of processor-executable instructions or data; and
at least one processor communicably coupled to the at least one nontransitory processor-readable storage medium, in operation the at least one processor:
stores a scripted macro command corresponding to a plurality of actions relating to the target application on the at least one nontransitory processor-readable storage medium;
generates a graphical user interface (GUI) having at least one interactive element, the GUI viewable on a display of the processor-based system concurrently with an active GUI of the target application;
associates the at least one interactive element with the macro command;
receives an activation of the interactive element; and
responsive to receipt of the activation of the at least one interactive element, executes the macro command to cause execution of the plurality of actions relating to the target application.

48. The system of claim 47 wherein the at least one processor:
monitors execution of the macro command over a period of time; and
stores analytics data for the macro command on the at least one nontransitory processor-readable storage medium based at least in part on the monitoring of the execution of the macro command over the period of time.

49. The system of claim 48 wherein the at least one processor:
generates a GUI which includes an analytics interactive element;
receives an activation of the analytics interactive element; and
responsive to receipt of the activation of the analytics interactive element, causes a display of analytics information on the display of the processor-based system, the analytics information based at least in part on the stored analytics data.

50. The system of claim 49 wherein the at least one processor:
causing a display of at least one of a chart, a table, or a graph.

51. The system of claim 48 wherein the at least one processor:
stores at least one of: a number of executions of the macro command during the period of time, or a cumulative amount of time saved by executing the macro command during the period of time.

52. The system of claim 48 wherein the at least one processor:
evaluates the analytics data for the macro command; and
responsive to the evaluation of the analytics data for the macro command, provides a suggestion message viewable on the display of the processor-based system, the suggestion message relating to at least one of: a suggestion to modify the macro command, or a suggestion to utilize another macro command.

53. The system of claim 47 wherein the macro command includes at least one of: a keyboard command, a mouse command, a sub-macro command, a delay period, an application programming interface (API) command, or an operating system command.

54. The system of claim 47 wherein the at least one processor:
monitors a state of the target application;
determines whether the macro command can be executed based at least in part on the state of the target application;
responsive to a determination that the macro command can be executed based at least in part on the state of the target application, enables the at least one interactive element for activation; and
responsive to a determination that the macro command cannot be executed based at least in part on the state of the target application, disables the at least one interactive element for activation.

55. A processor-based system to share user-generated macro commands associated with a target software application, the system comprising:
at least one nontransitory processor-readable storage medium that stores at least one of processor-executable instructions or data; and
at least one processor communicably coupled to the at least one nontransitory processor-readable storage medium, in operation the at least one processor:
stores a plurality of macro commands on the at least one nontransitory processor-readable storage medium, the at least one nontransitory processor-readable storage medium accessible by a plurality of processor-based devices associated with a plurality respective users via at least one data communications network;
organizes the plurality of macro commands according to one or more criteria;
presents a visual representation of at least a portion of the organized macro commands to a processor-based device associated with a user, the visual presentation based at least in part on the organizing of the plurality of macro commands;
receives a selection of one of the organized macro commands from the processor-based device associated with the user; and
provides the selected one of the organized macro commands to the processor-based device associated with the user via the at least one data communications network.

56. The system of claim 55 wherein the at least one processor:
ranks the plurality of macro commands according to one or more criteria.

57. The system of claim 56 wherein the at least one processor:
ranks the plurality of macro commands based at least in part on: a detected frequency of use of each of the macro commands, or a user rating of each of the macro commands.

58. The system of claim 55 wherein the at least one processor:
organizes the plurality of macro commands based at least in part on a nested hierarchy of categories and sub-categories.

59. The system of claim 55 wherein the at least one processor:
organizes the plurality of macro commands based at least in part on: a user type, an organizational unit, an operating system type, or a target application type.

60. A processor-based system to provide a simplified interface for a target application which executes on the processor-based system, the system comprising:
at least one nontransitory processor-readable storage medium that stores at least one of processor-executable instructions or data; and
at least one processor communicably coupled to the at least one nontransitory processor-readable storage medium, in operation the at least one processor:
monitors a plurality of actions within a graphical user interface (GUI) of the target application over a period of time;
autonomously identifies at least one pattern of actions in the plurality of actions, the pattern comprising at least two actions relating to the target application;
autonomously generates a macro command corresponding to the at least two actions in the pattern of actions relating to the target application;
stores the generated macro command on the at least one nontransitory processor-readable storage medium;
generates a GUI having at least one interactive element, the GUI viewable on a display of the processor-based system concurrently with the GUI of the target application;
associates the at least one interactive element with the macro command;
receives an activation of the interactive element; and
responsive to receipt of the activation of the at least one interactive element, executes the macro command to cause execution of the at least two actions relating to the target application.

61. The system of claim 60 wherein the at least one processor:
monitors a plurality of actions executed by a single user.

62. The system of claim 60 wherein the at least one processor:
monitors a plurality of actions executed by a plurality of users.

63. The system of claim 60 wherein the at least one processor:
monitors at least one of: a keyboard command, a mouse command, a sub-macro command, a delay period, an application programming interface (API) command, or an operating system command.

64. The system of claim 60 wherein the at least one processor:
monitors execution of a sub-macro command relating to the target application, and generating a macro command comprises generating a macro command which includes the sub-macro command and at least one additional action relating to the target application.

65. A processor-based system to share user-generated macro commands associated with a target software application, the system comprising:
at least one nontransitory processor-readable storage medium that stores at least one of processor-executable instructions or data; and
at least one processor communicably coupled to the at least one nontransitory processor-readable storage medium, in operation the at least one processor:
stores a plurality of macro commands on at least one nontransitory processor-readable storage medium;
for each of the plurality of macro commands, identifies a number of processor-based devices which utilize the macro command;
modifies at least one macro command of the plurality of macro commands; and
provides the modified macro command to each of the number of the processor-based devices identified as utilizing the macro command via at least one data communications network.

66. The system of claim 65 wherein the at least one processor:
provides the modified macro command to each of the number of processor-based devices via the at least one data communications network without receipt of a request for the modified macro command from at least one of the number of the processor-based devices.

67. The system of claim 65 wherein the at least one processor:
provides access to the modified macro command to each of the number of processor-based devices over the at least one data communications network.
